(19) United States
(12) Patent Application Publication
(10) Pub. No.: US 2011/0177956 A1
(43) Pub. Date: Jul. 21, 2011

(54) METHOD AND SYSTEM OF PREDICTING CLINICAL OUTCOME FOR A PATIENT WITH CONGESTIVE HEART FAILURE

(75) Inventor: Michael KORENBERG, Battersea (CA)

(73) Assignee: Queen's University at Kingston, Kingston (CA)

(21) Appl. No.: 12/887,752

(22) Filed: Sep. 22, 2010

Related U.S. Application Data
(60) Provisional application No. 61/244,756, filed on Sep. 22, 2009.

(51) Int. Cl. C40B 30/00

(52) U.S. Cl. 506/7

(57) ABSTRACT

A method of predicting a clinical outcome for a patient with congestive heart failure is disclosed. A plurality of nonlinear first PCI models are identified based on a biomarker dataset, each of the models having a number of distinct terms. One or more second PCI models are identified based on the biomarker dataset, each of these models having a number of distinct terms which corresponds to the number of distinct terms for one or more of the nonlinear first PCI models. Each of the plurality of nonlinear first PCI models are statistically compared to one of the one or more second PCI models having a corresponding number of distinct terms to determine a preference for higher versus lower degree of nonlinearity or preference for shorter versus longer memory length. The clinical outcome is predicted based on the preference for higher versus lower degree of nonlinearity or memory length preference.

### RELATED APPLICATIONS

This application claims priority to U.S. provisional patent application 61/244,756 filed Sep. 22, 2009, and entitled, “Method and System of Predicting Clinical Outcome for a Patient with Congestive Heart Failure.” The same U.S. provisional patent application 61/244,756 is hereby incorporated by reference in its entirety.

### FIELD

The claimed invention relates to the assessment and diagnosis of the heart, and more particularly to methods and systems which predict a clinical outcome for a patient with congestive heart failure based on analysis of a biomarker dataset.

### BACKGROUND

The human heart 20, schematically illustrated in FIG. 1, has four contractile chambers which work together to pump blood throughout the body. The upper chambers are called atria, and the lower chambers are called ventricles. The right atrium 22 receives blood 24 that has finished a tour around the body and is depleted of oxygen. This blood 24 returns through the superior vena cava 26 and inferior vena cava 28. The right atrium 22 pumps this blood through the tricuspid valve 30 into the right ventricle 32, which pumps the oxygen-depleted blood 24 through the pulmonary valve 34 into the right and left lungs 36, 38. The lungs oxygenate the blood, and eliminate the carbon dioxide that has accumulated in the blood due to the body's many metabolic functions. The oxygenated blood 40 returns from the right and left lungs, 36, 38 and enters the heart's left atrium 42, which pumps the oxygenated blood 40 through the bicuspid valve 44 into the left ventricle 46. The left ventricle 46 then pumps the blood 40 through the aortic valve 48 into the aorta 50 and back into the blood vessels of the body. The left ventricle 46 has to exert enough pressure to keep the blood moving throughout all the blood vessels of the body. The heart is a complex and amazing organ which everyone relies on to remain healthy for a good quality of life.

Unfortunately, conditions inside and outside of a person's body can sometimes cause heart failure. Heart failure is characterized by the condition when the pumping action of the heart becomes less powerful. With heart failure, blood moves through the heart and body slowly, and pressure in the heart increases. When a person's heart is failing, it is unable to pump as much oxygen rich blood as the body needs. As a result, the chambers of the heart have to stretch to hold more blood to pump through the body. This causes the walls of the chambers to become stiffer and more thickened. Eventually, the heart muscle walls weaken and cannot pump as strongly as they used to. As blood flow out of the heart slows, blood returning to the heart through the veins backs up, causing congestion in the tissues. Often, swelling in the legs and ankles results, although it can happen in other parts of the body, too. Sometimes fluid collects in the lungs and interferes with breathing, causing shortness of breath, especially when a person is lying down. Heart failure can also affect the kidney's ability to dispose of sodium and water. This retained water increases bodily swelling, and fluid can further build up in the arms, legs, lungs or other organs. In other words, the body becomes congested from heart failure because the heart is not working as efficiently as it should. This condition is known as Congestive Heart Failure (CHF).

There are numerous ways to identify patients who have congestive heart failure (CHF). For example, Ho et al., in an article entitled, “Predicting survival in heart failure case and control subjects by use of fully automated methods for deriving nonlinear and conventional indices of heart rate dynamics,” as published in Circulation [96(3), 842-848, 1997], analyzed ambulatory electrocardiogram (ECG) recordings and heart rate variability by time-domain measures (mean and standard deviation of heart rate), by frequency-domain measures (power in the bands from 0.001 to 0.01 Hz, 0.01 to 0.15 Hz, and 0.15 to 0.5 Hz and total spectral power over all three of these bands), and by methods based on nonlinear dynamics. Their study samples included twenty-eight CHF patients and forty-one sex and age matched control subjects. The authors concluded that there were statistically significant differences between the CHF patients and control subjects. The standard deviation of the heart rate, very-low-frequency power, low-frequency power, and the ratio of low-frequency to high-frequency power were lower in the CHF patients than in the healthy control subjects. The detrended fluctuation analysis index, ranging between 0 and 1, with 1 indicating perfectly normal scaling behavior, was also lower in the CHF patients, indicating a lower amount of long-range correlations compared with the control subjects, and offering a way to screen healthy subjects from those having CHF. Unfortunately, however, this method does not allow for further screening of the CHF patients to separate out those with high-risk CHF from those with low-risk CHF.

Poon and Merrill, in an article entitled, “Decrease of cardiac chaos in congestive heart failure,” as published in Nature 389, 492-495, 1997, applied the Fast Orthogonal Algorithm from Korenberg's article entitled, “Identifying nonlinear difference equation and functional expansion representations—the Fast Orthogonal Algorithm,” from the Annals of Biomedical Engineering 16(1), 123-142, 1988, to the problem of distinguishing between electrocardiograms of a group of subjects with severe congestive heart failure and those of healthy subjects. They generated several Volterra-Wiener-Korenberg (VWK) series with different degrees of nonlinearity and embedding dimensions to produce a family of linear and nonlinear polynomial autoregressive models. Poon and Merrill used the data sets of heartbeat intervals from eight healthy subjects and eleven CHF patients. The histograms of linear and nonlinear model selection for all 500-beat and 2000-beat data segments based on the statistical tests, in healthy subjects and CHF patients, showed high detection rates for chaos in the healthy group and relatively low detection rates for chaos in the CHF group. As a result, Poon and Merrill discovered that cardiac chaos is displayed in the healthy heart, and it is decreased in CHF. While this method provides another way to differentiate between healthy patients and those who have CHF, it unfortunately does not allow for further screening of the CHF patients to separate out those with high-risk CHF from those with low-risk CHF.

Congestive Heart Failure (CHF) can often be treated by increasing rest, improving or changing a diet, modification of a person's daily activities, and/or the prescription of drugs such as ACE inhibitors, beta blockers, digitalis, diuretics, and vasodilators. While some treatments for CHF may be implemented by patients on their own, other methods require the services of a medical professional to assist with further diagnosis, testing, prescription of medications, follow-up monitoring, and even surgical procedures to correct a potentially repairable cause of the CHF. Medical professionals with the necessary skills to assist with CHF patients are in limited supply, while more and more patients are diagnosed each year with CHF. In the United States, for example, there are approximately five million patients suffering from heart failure, with over five hundred thousand new patients being diagnosed with CHF each year. As pointed out above, while many techniques exist to identify CHF, there unfortunately is no clinically reliable way to differentiate between low-risk patients (for example, those who might respond well to more moderate treatments) and high-risk CHF patients (for example, those who may be in need of aggressive treatments and monitoring to prevent an imminent stroke or death.)

Therefore, there is a need for a reliable method and system for predicting clinical outcome for a patient with congestive heart failure so that high-risk CHF patients may be quickly identified and matched with the necessary medical professionals/treatments.

### SUMMARY

A method of predicting a clinical outcome for a patient with congestive heart failure is disclosed. A biomarker dataset is provided. A plurality of nonlinear first parallel cascade identification (PCI) models are identified based on the biomarker dataset, each of the nonlinear first PCI models having a number of distinct terms. One or more second PCI models are identified based on the biomarker dataset, each of the one or more second PCI models having a number of distinct terms which corresponds to the number of distinct terms for one or more of the nonlinear first PCI models. Each of the plurality of nonlinear first PCI models is statistically compared to one of the one or more second PCI models having a corresponding number of distinct terms to determine a preference for higher versus lower degree of nonlinearity or a preference for shorter versus longer memory length. The clinical outcome is predicted based on the degree of nonlinearity preference or memory length preference.

Another method of predicting a clinical outcome for a patient with congestive heart failure is also disclosed. A biomarker dataset is provided. A plurality of nonlinear first black-box models are provided based on the biomarker dataset, each of the nonlinear first black-box models having a number of distinct terms. One or more second black-box models are identified based on the biomarker dataset, each of the one or more second black-box models having a number of distinct terms which corresponds to the number of distinct terms for one or more of the nonlinear first black-box models. Each of the plurality of nonlinear first black-box models is statistically compared to one of the one or more second black-box models having a corresponding number of distinct terms to determine a preference for higher versus lower degree of nonlinearity or a preference for shorter versus longer memory length. The clinical outcome is predicted based on the degree of nonlinearity preference or memory length preference.

A method of determining an effect of a pharmacological agent on a patient with congestive heart failure is also disclosed. A baseline biomarker dataset is provided. A baseline plurality of nonlinear first parallel cascade identification (PCI) models are identified based on the baseline biomarker dataset, each of the nonlinear first PCI models having a number of distinct terms. One or more baseline second PCI models are identified based on the baseline biomarker dataset, each of the one or more baseline second PCI models having a number of distinct terms which corresponds to the number of distinct terms for one or more of the baseline nonlinear first PCI models. Each of the baseline plurality of nonlinear first PCI models is statistically compared to one of the one or more baseline second PCI models having a corresponding number of distinct terms to determine a baseline preference for higher versus lower degree of nonlinearity or a baseline preference for shorter versus longer memory length. A baseline clinical outcome is predicted based on the baseline degree of nonlinearity preference or baseline memory length preference. The pharmacological agent is administered to the patient. A post-administration biomarker dataset is provided. A post-administration plurality of nonlinear first parallel cascade identification (PCI) models are identified based on the post-administration biomarker dataset, each of the nonlinear first PCI models having a number of distinct terms. One or more post-administration second PCI models are identified based on the post-administration biomarker dataset, each of the one or more post-administration second PCI models having a number of distinct terms which corresponds to the number of distinct terms for one or more of the post-administration nonlinear first PCI models. Each of the post-administration plurality of nonlinear first PCI models is statistically compared to one of the one or more post-administration second PCI models having a corresponding number of distinct terms to determine a post-administration preference for higher versus lower degree of nonlinearity or a post-administration preference for shorter versus longer memory length. A post-administration clinical outcome is predicted based on the post-administration degree of nonlinearity preference or post-administration memory length preference. The baseline and post-administration clinical outcomes are compared to determine the effect of the pharmacological agent on the patient.

A computer readable medium having stored thereon instructions for predicting a clinical outcome for a patient with congestive heart failure is also disclosed. The instructions, when executed by a processor, cause the processor to: a) provide a biomarker dataset; b) identify a plurality of nonlinear first parallel cascade identification (PCI) models based on the biomarker dataset, each of the nonlinear first PCI models having a number of distinct terms; c) identify one or more second PCI models based on the biomarker dataset, each of the one or more second PCI models having a number of distinct terms which corresponds to the number of distinct terms for one or more of the nonlinear first PCI models; d) statistically compare each of the plurality of nonlinear first PCI models to one of the one or more second PCI models having a corresponding number of distinct terms to determine a preference for higher versus lower degree of nonlinearity or a preference for shorter versus longer memory length; and e) predict the clinical outcome based on the degree of nonlinearity preference or memory length preference.

A system for predicting a clinical outcome for a patient with congestive heart failure is also disclosed. The system has a processor configured to predict the clinical outcome based on a preference for higher versus lower degree of nonlinearity or a preference for shorter versus longer memory length determined from a statistical comparison of a plurality of nonlinear first PCI models and at least one second PCI model which are identified to approximate a biomarker dataset based on electrocardiogram (ECG) data. The system also has a data input coupled to the processor and configured to provide the processor with the ECG data. The system further has a user interface coupled to either the processor or the data input, or both.

A method of predicting a clinical outcome for a patient is disclosed. A biomarker dataset is provided. A plurality of nonlinear first parallel cascade identification (PCI) models are identified based on the biomarker dataset, each of the nonlinear first PCI models having a number of distinct terms. One or more second PCI models are identified based on the biomarker dataset, each of the one or more second PCI models having a number of distinct terms which corresponds to the number of distinct terms for one or more of the nonlinear first PCI models. Each of the plurality of nonlinear first PCI models is statistically compared to one of the one or more second PCI models having a corresponding number of distinct terms to determine a preference for higher versus lower degree of nonlinearity or a preference for shorter versus longer memory length. The clinical outcome is predicted based on the degree of nonlinearity preference or memory length preference.

It is at least one goal of the claimed invention to provide an improved method which predicts a clinical outcome for a patient with congestive heart failure.

### BRIEF DESCRIPTION OF THE DRAWINGS

FIG. 1 schematically illustrates the operation of a human heart.

FIG. 2 schematically illustrates an embodiment of an electrocardiogram (ECG) showing one heart beat.

FIG. 3 schematically illustrates one embodiment of a black-box modeling approach.

FIG. 4 illustrates one embodiment of a method for predicting a clinical outcome for a patient with congestive heart failure.

FIG. 5 schematically illustrates one embodiment of a parallel cascade model.

FIG. 6 schematically illustrates one embodiment of a structure of an i-th cascade for a parallel cascade model.

FIG. 7 illustrates another embodiment of a method for predicting a clinical outcome for a patient with congestive heart failure.

FIGS. 8-10 schematically illustrate different embodiments of a congestive heart failure prediction system for predicting a clinical outcome for a patient with congestive heart failure.

FIG. 11 illustrates one embodiment of a method for determining an effect of a pharmacological agent on a patient with congestive heart failure.

FIG. 12 schematically illustrates another embodiment of a congestive heart failure prediction system for predicting a clinical outcome for a patient with congestive heart failure.

FIG. 13A illustrates representative R-R wave intervals from a high-risk congestive heart failure patient from a 5-year study.

FIG. 13B illustrates representative R-R wave intervals from a low-risk congestive heart failure patient from the 5-year study.

FIG. 14A illustrates variance of R-R wave intervals of all high-risk patients in a smaller test set.

FIG. 14B illustrates variance of R-R wave intervals of all low-risk patients in the smaller test set.

FIG. 15A illustrates parallel cascade identification model comparisons from a high-risk patient in the smaller test set.

FIG. 15B illustrates parallel cascade identification model comparisons from a low-risk patient in the smaller test set.

FIG. 16 illustrates results of an MN-Wilcoxon test for the smaller test dataset.

FIG. 17 illustrates results of an MN-Wilcoxon test for a larger test dataset.

FIG. 18 illustrates one embodiment of a 2×2 contingency table.

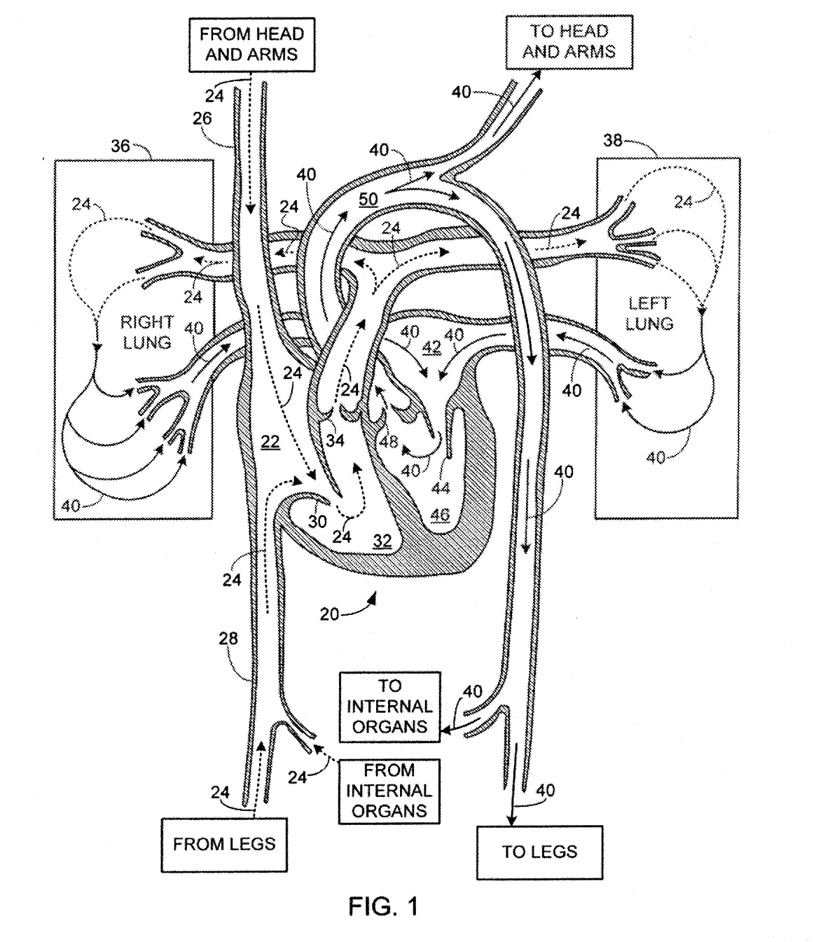

It will be appreciated that for purposes of clarity and where deemed appropriate, reference numerals have been repeated in the figures to indicate corresponding features, and that the various elements in the drawings have not necessarily been drawn to scale in order to better show the features.

### DETAILED DESCRIPTION

Many different types of biomarker data may be provided for the heart. Different non-limiting examples of heart biomarker data may include measurements of one or more proteins, measurements of one or more electrolyte levels, and measurement of the electrical activity of the heart. For example, a surface electrocardiogram (ECG) may be measured by an ECG capture device which can have one or more leads which are coupled to a person's body in various locations. The electrical activity occurring within individual cells throughout the heart produces a cardiac electrical vector which can be measured at the skin's surface by the ECG capture device leads. The signal registered at the skin's surface originates from many simultaneously propagating activation fronts at different locations, each of which affects the size of the total component. One type of ECG capture device is a twelve-lead signal device, although ECG capture devices of any number of leads may be used to gather a set of ECG signals for use as biomarkers.

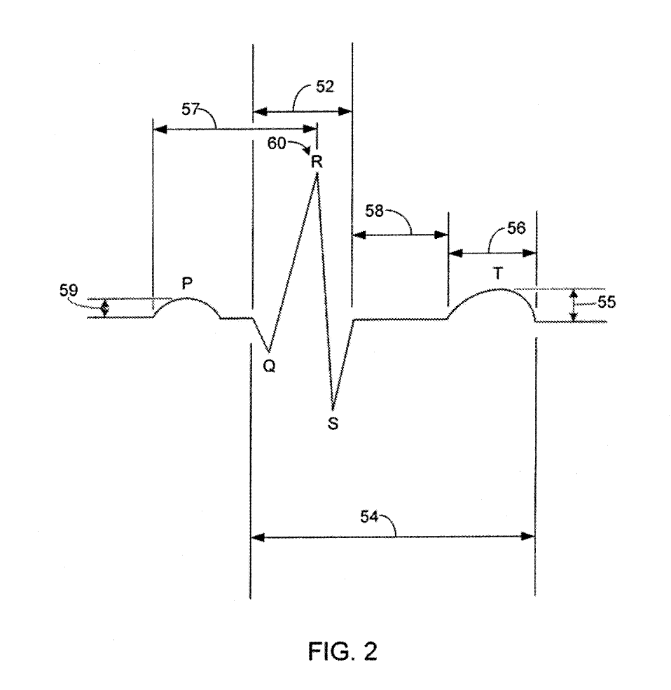

While an ECG signal itself could be considered a biomarker, other types of biomarker data may be derived from one or more ECG signals. For example, FIG. 2 schematically illustrates an embodiment of an ECG showing one heart beat and some of the biomarkers which are commonly determined based on various portions of the ECG signal. The QRS complex 52 is associated with the depolarization of the heart ventricles. The QT interval 54 and the T-wave 56 are associated with repolarization of the heart ventricles. The ST segment 58 falls between the QRS complex 52 and the T-wave 56. When consecutive ECG beats are examined together, the time between R-peaks 60 can be determined. This is commonly called the R-R interval. The inverse of the R-R interval is the heart rate. Those skilled in the art will recognize that there are a multitude of available ECG-based biomarkers, and that this list is just provided as an example. Other non-limiting examples include the amplitude of the T wave 55, a PR interval 57, the amplitude of the P wave 59, and a direction of a significant axis determined by principal component analysis. For convenience, many of the examples used in this specification will be based on biomarkers which are based on ECGs. However, it should be understood that there are many other types of heart biomarkers which could be used with the methods and systems disclosed herein, such modifications and substitutions being well within the abilities of one skilled in the art, and therefore intended to be covered by the claims to the invention.

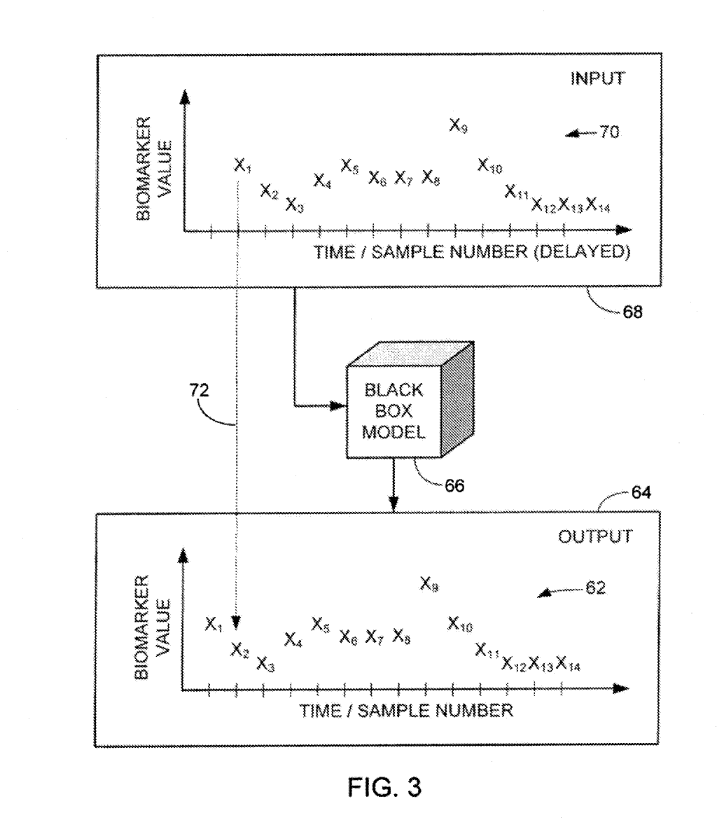

A biomarker dataset may be modeled using a “black-box” approach. For example, consider the biomarker dataset 62 schematically illustrated in FIG. 3. Different biomarker values X₁ through X₁₄ have been measured, collected, or determined over time. The provided biomarker dataset 62 can be thought of as an output 64 generated by a black-box model 66 in response to some known input 68. With some systems, it may be possible to separately measure the input 68, but in the case of the biomarker datasets considered herein, the input 68 cannot be directly measured. Instead, one or more different inputs 68 can be assumed for the black-box model 66 by delaying the output biomarker dataset 62 by a certain time or number of samples and saying that this delayed output biomarker dataset 70 is the input 68 to the black-box model 66. The delay can clearly be seen in FIG. 3 by following line 72 which illustrates for a corresponding time or sample number that the value Xᵢ for the input biomarker dataset 70 (also known as the delayed output biomarker dataset 70) occurs at the same time as the value X₂ for the output biomarker dataset 62. In order for each input and output value to be known, it is convenient to consider our (input, output) record in this example to be (X₁, X₂), . . . , (X₁₃, X₁₄). The delay value may be varied so that different black-box models may be developed for the output using different inputs for each case. The delay value is not a memory length. The delay is how far back the memory starts. The memory length is how many of the earlier data values are included in the model. For example, to predict X₁₀ with a delay=1 and a memory length=3, the model would use X₉, X₈, and X₇ as input. As another example, to predict X₁₀ with a delay=2 and a memory length=3, the model would use X₈, X₇, and X₆.

Although it is simple to say that an input biomarker dataset 70 (which we can define by delaying a known output biomarker dataset 62) passes through a black-box model 66 to produce the output biomarker dataset, the process of coming up with a suitable black-box model can take many forms. While several black-box modeling methods may be available to those skilled in the art, it is preferable to utilize a method of black-box modeling which allows the system to statistically compare a series of black-box models to determine a preference for higher versus lower degree of nonlinearity or a preference for shorter versus longer memory length of the modeled biomarker dataset, since it has been discovered that a clinical outcome for congestive heart failure may be predicted based on the preferred degree of nonlinearity or memory length preference.

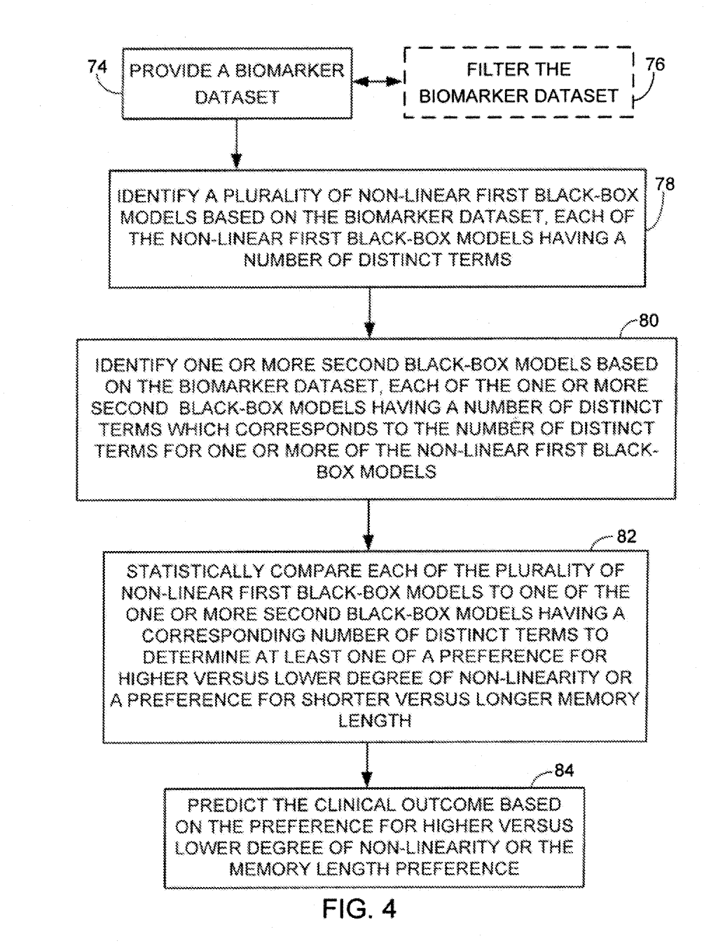

FIG. 4 illustrates one embodiment of a method for predicting a clinical outcome (for example, survival vs. death) for a patient with congestive heart failure. A biomarker dataset is provided 74. Non-limiting examples of suitable biomarkers have been discussed above. For simplicity, a biomarker dataset derived from ECG signals is discussed in more detail for this embodiment. However, it should be understood that other types of biomarker datasets may be used. If using ECG signals, the ECG signals may be provided from a variety of ECG capture devices as discussed above. The ECG signals may be provided in “real-time” from a subject coupled to an ECG capture device, or the ECG signals may be provided from a database (which should be understood to include memory devices) storing previously obtained ECG signals. In some embodiments, the biomarker dataset may optionally be filtered 76. One suitable method of filtering ECG signals is to apply digital low-pass finite impulse response (FIR) filtering to remove baseline wandering. Another suitable method of filtering ECG signals to remove baseline wander is to subtract a baseline estimation arrived-at using spline interpolation. In other embodiments, the optional filtering 76 may include statistical combinations of multiple beats from the ECG signals. As a non-limiting example, a median beat may be created from a number of consecutive beats from each lead. In some embodiments, one or more leading beats may be discarded. In other embodiments, one or more trailing beats may be discarded. In still other embodiments, only beats with a stable heart rate may be taken into account. An example of a suitable definition of beats with a stable heart rate is when the heart rate for a given beat varies less than ten percent in beats of the previous two minutes. In other embodiments other percentages, time-frames, and definitions of a stable heart rate may be used without deviating from the scope of the claimed invention.

A plurality of nonlinear first black-box models are identified 78 based on the biomarker dataset, each of the nonlinear first black-box models having a number of distinct terms. One suitable example of a black-box model which can be used is a “Parallel Cascade Identification” model. Parallel Cascade Identification (PCI) models were proposed by Korenberg in an article entitled “Statistical identification of parallel cascades of linear and nonlinear systems” published in Proc. 6th IFAC Symposium on Identification and System Parameter Estimation 1,580-585, 1982, and further described in an article entitled “Parallel cascade identification and kernel estimation for nonlinear systems” published in Annals of Biomedical Engineering 19, 429-455, 1991. Both of these articles are hereby incorporated by reference in their entirety. Further details related to PCI models will be discussed later in this specification.

One or more second black-box models are identified 80 based on the biomarker dataset, each of the one or more second black-box models having a number of distinct terms which corresponds to the number of distinct terms for one or more of the nonlinear first black-box models. The one or more second black box models may also be PCI models in some embodiments. In some embodiments, each of the one or more second black-box models may be a substantially linear black-box model based on the biomarker dataset. A substantially linear model 1) may have no nonlinear terms, 2) may have linear and nonlinear terms, provided the degree of nonlinearity (the highest power) is substantially equal to one, or 3) may have only nonlinear terms, again, provided the degree of nonlinearity is substantially equal to one. In other embodiments, each of the one or more second black box models may be nonlinear black-box models.

Each of the plurality of nonlinear first black-box models is statistically compared 82 to one of the one or more second black-box models having a corresponding number of distinct terms to determine a preference for higher versus lower degree of nonlinearity or a preference for shorter versus longer memory length. Each of the plurality of nonlinear first black-box models will have its own degree of nonlinearity. In the case where the second black-box models are nonlinear black-box models, each of the one or more second black box models will have another degree of nonlinearity. In this case, the degree of nonlinearity of each of the plurality of nonlinear first black-box models may be the same as or different from the degree of the nonlinearity of the nonlinear second black-box model to which it is compared.

Systems that exhibit mathematical chaos are deterministic and thus orderly in some sense; this technical use of the word chaos is at odds with common language, which suggests complete disorder. However, even though they are deterministic, chaotic systems show a strong kind of unpredictability not shown by other deterministic systems. Therefore, a system exhibiting more chaos tends to be more unpredictable, while a system exhibiting less chaos tends to be more predictable. Poon et al, in an article entitled “Decrease of cardiac chaos in congestive heart failure” as published in Nature 389, 492-495, 1997, showed that patients identified with congestive heart failure are known to exhibit less chaos in their ECG datasets. Therefore, patients with congestive heart failure could be considered to have more predictable systems while healthier patients could be considered to have less predictable systems. This research would seem to indicate that, among congestive heart failure patients, those closer to the healthier end of the spectrum would have less predictable or higher-degree nonlinear systems. Surprisingly, however, it has been discovered that the congestive heart failure patients exhibiting a higher degree of nonlinearity in the statistical comparison are predicted 84 to have an unfavorable clinical outcome (for example, death).

Since Parallel Cascade Identification (PCI) is used in many of the embodiments, it is helpful to have a better understanding of PCI. Before describing PCI, however, it is necessary to introduce Volterra series. Volterra introduced mathematical models of nonlinear systems called Volterra series or Volterra functional expansions which are known to those skilled in the art. Volterra indicated that some systems may be represented by a sum of Volterra functionals. Equation (1) shows an I^{th} order Volterra series for a continuous-time time-invariant system.

$$y ( t ) = {h}_{0} + {\int }_{0}^{R} {h}_{1} ( τ ) x ( t - τ ) d τ + {\int }_{0}^{R} {\int }_{0}^{R} {h}_{2} ( {τ}_{1} , {τ}_{2} ) x ( t - {τ}_{1} ) x ( t - {τ}_{2} ) d {τ}_{1} d {τ}_{2} + … + {\int }_{0}^{R} … {\int }_{0}^{R} {h}_{I} ( {τ}_{1} , … {τ}_{I} ) x ( t - {τ}_{1} ) … x ( t - {τ}_{I} ) d {τ}_{1 } … d {τ}_{I} \\ or \\ y ( t ) = {\sum }_{i = 0}^{I} {y}_{i} ( t ) , {y}_{i} ( t ) = {\int }_{0}^{R} … {\int }_{0}^{R} {h}_{i} ( {τ}_{1} , … {τ}_{i} ) x ( t - {τ}_{1} ) … x ( t - {τ}_{i} ) d {τ}_{1 } … d {τ}_{i} \qquad ( 1 )$$

The right side of the upper equation is called a Volterra series of I^{th}-order. hᵢ(τ₁, . . . τᵢ) is the i^{th}-order Volterra kernel. hᵢ, is the zero^{th}-order Volterra kernel and is constant. R is the memory length of the model. Both R and I may be infinite. The term

$${y}_{i} ( t ) = {\int }_{0}^{R} … {\int }_{0}^{R} {h}_{i} ( {τ}_{1} , … {τ}_{i} ) x ( t - {τ}_{1} ) … x ( t - {τ}_{i} ) d {τ}_{1 } … d {τ}_{i}$$

is the i^{th}-order Volterra functional. The i^{th}-order functional is homogeneous of degree i because if input x(t) is replaced by c·x(t), then the i^{th}-order functional yᵢ(t) is multiplied by cⁱ. Note that each Volterra kernel hᵢ(τ₁, . . . , τᵢ) may be assumed to be symmetric, i.e., invariant with respect to any permutation of τ₁, . . . , τᵢ without any loss in generality.

Equation (1) is an I^{th}-order Volterra series with memory length R. If I is finite, then the Volterra series is of finite order. If R is finite, then the Volterra series has finite memory. If both I and R are finite, then the series is said to be doubly finite.

Most nonlinear systems are not analytic (systems for which certain functional derivatives of all orders exist), however, and cannot be exactly represented by a Volterra series. Frechet considered a finite-memory, causal nonlinear system whose output is a continuous mapping of its input, in that “small” changes in the input produce “small” changes in the output. Then, over a uniformly-bounded equi-continuous set of input signals, the nonlinear system can be uniformly approximated, to an arbitrary degree of accuracy, by a Volterra series of sufficient, but finite, order.

Another type of model is the discrete-time model considered by Palm in an article entitled “On Representation and Approximation of Nonlinear Systems. Part II: Discrete Time” as published in Biological Cybernetics 34, 49-52, 1979. As a direct result of the Stone-Weierstrass theorem, Palm noted that a discrete-time causal finite-memory time-invariant system, whose output is a continuous mapping of its input, may be uniformly approximated over a uniformly-bounded set of input signals by a discrete-time Volterra series of sufficient, but finite, order. Equation (2) shows the representation of a discrete-time causal Volterra series. In the equation, hₘ(j₁, . . . , jₘ) is the m^{th}-order Volterra kernel.

$$y ( n ) = {h}_{0} + {\sum }_{j = 0}^{R} {h}_{1} ( j ) x ( n - j ) + {\sum }_{{j}_{1} = 0}^{R} {\sum }_{{j}_{2} = 0}^{R} {h}_{2} ( {j}_{1} , {j}_{2} ) x ( n - {j}_{1} ) x ( n - {j}_{2} ) + … + {\sum }_{{j}_{1} = 0}^{R} … {\sum }_{{j}_{m} = 0}^{R} {h}_{m} ( {j}_{1} , … , {j}_{m} ) x ( n - {j}_{1} ) … x ( n - {j}_{m} ) \qquad ( 2 )$$

Although this is of great theoretical use, the required order of the Volterra series might need to be very large in order to accurately approximate a given nonlinear system over a given uniformly-bounded set of input signals. In practice, Volterra series are usually applied only to systems with an order of nonlinearity less than or equal to three. Another problem is that, to find the Volterra kernels, a set of simultaneous linear equations must be solved, involving inversion of a matrix whose size grows rapidly with R. In Equation (2), the output depends on input lags 0, . . . R, so the memory length is often said to be R+1.

A parallel cascade model that consists of a finite sum of dynamic linear, static nonlinear, and dynamic linear (LNL) cascades was proposed by Palm in the above article to uniformly approximate discrete-time systems that could be approximated by Volterra series. Palm showed that any system having a Volterra series representation with finite memory and anticipation could be uniformly approximated to an arbitrary degree of accuracy by a sum of a sufficient, but finite, number of LNL cascades. In Palm's proof, the static nonlinearities were exponential and logarithmic functions.

Each of the parallel paths includes a cascade, or a series connection of elements. The output of the first element (dynamic linear element) is the input to the second (static nonlinear element); the output of the second element is the input to the third (dynamic linear element). However, Palm did not describe any procedure for identifying the model or building a parallel cascade approximation for a dynamic nonlinear system.

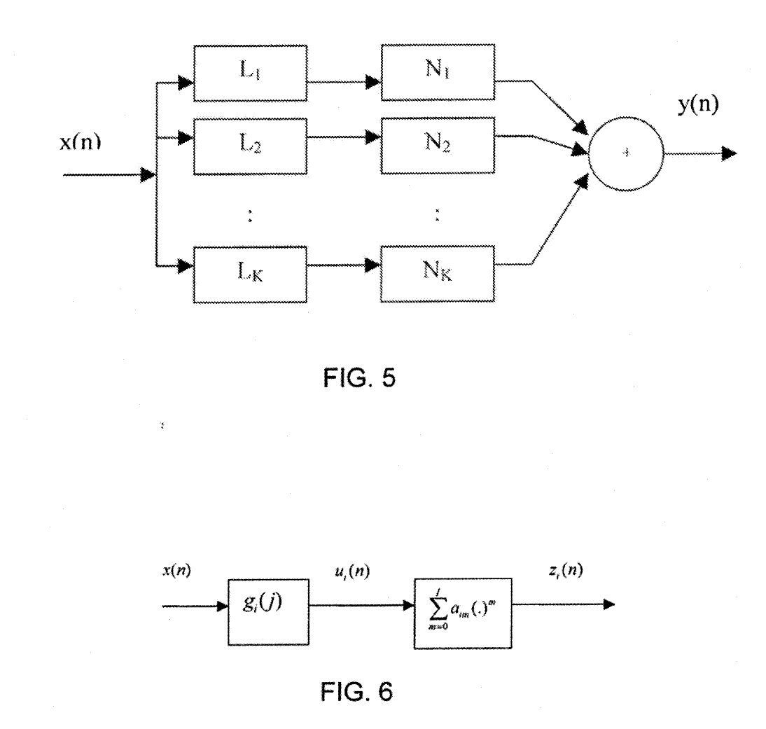

Based on Palm's promising proposal, Korenberg subsequently developed a particular parallel cascade model (PCI model): each cascade has a dynamic linear (L) element and polynomial static nonlinear (N) element. Korenberg's parallel cascade model structure is schematically illustrated in FIG. 5. Each L is a dynamic linear element, and each N is a polynomial static nonlinear element. Except where indicated, such an LN structure is used in the PCI embodiments. However, many other cascade structures could be used, and still be considered a PCI model. For example, a cascade might begin with a static nonlinearity, or the polynomials could be replaced by linear combinations of fractional powers or could be other nonlinearities, or a cascade may comprise more alternating dynamic linear and static nonlinear elements. Korenberg also proposed an identification procedure for obtaining such a parallel LN model, given only input and output data, to approximate any discrete-time system which has a Wiener series representation to an arbitrary degree of accuracy in the mean-square sense. As those skilled in the art are aware, Wiener series can be derived by applying the Gram-Schmidt orthogonalisation process to the functionals in the Volterra series, for a particular white Gaussian input.

One version of a parallel cascade identification modeling process is summarized below, but other approaches will be known to those skilled in the art and the method is not limited to the process summarized here. A first cascade of dynamic linear and static nonlinear elements is found to approximate the dynamic nonlinear system to be identified. The residual, the difference between the system output and the cascade output, is calculated, and then is treated as the output of a second dynamic nonlinear system driven by the same input. A cascade of dynamic linear and static nonlinear elements is now found to approximate the second system. The new residual is calculated, and treated as the output of a third nonlinear system, and so on. Each succeeding cascade is fit in order to drive the cross-correlations of the input with the residual to zero.

As an example, consider a discrete-time dynamic nonlinear system, where the only information known from the system is its input x(n) and output y(n), n=0, . . . , T (the 1^{st} to the (T+1)-th values of time). Suppose that yᵢ(n) denotes the residual after adding the i-th cascade to the model, and y₀(n)=y(n). The variable zᵢ(n) denotes the output of the i-th cascade. The structure of the i-th cascade is shown in FIG. 6, where gᵢ(j) denotes the discrete unit impulse response function of the dynamic linear element, uᵢ(n) is the output of this linear element, and the aₘ are the polynomial coefficients defining the static nonlinear element.

Then for i≧1, the i-th residual yᵢ(n), after adding the i-th cascade, is equal to the difference between the previous residual, yₜ₋₁(n) and the present cascade output zᵢ(n).

yᵢ(n)=yᵢ₋₁(n)−zᵢ(n) (3)

Before identifying a parallel cascade model, a number of basic parameters must be specified first:
R+1 is the memory length of the dynamic linear element.
I is the degree of the polynomial static nonlinearity that follows the linear element.
C is the maximum number of cascades permitted in the model.
Re is the maximum number of consecutive candidate cascades to be rejected before termination of the PCI process.
Th is a threshold constant, for deciding whether a cascade's reduction of the mean-square error (MSE), defined below in Equation (10), justifies its addition to the model.

The discrete impulse response function, gᵢ(j), of the dynamic linear element can be defined using a first-order cross-correlation, φ_{xy}_{ᵢ₋₁}(j), or a slice of a cross-correlation of higher order P, of the input x(n) with the latest residual, yᵢ₋₁(n). The order P that will be used to define gᵢ(j) can be selected at random, sometimes up to and sometimes greater than the assumed order (degree) of nonlinearity of the system to be identified. Equation (4) shows the discrete impulse response of a dynamic linear element when the first-, second-, third-, or fourth-order cross-correlation is employed. The maximum order set in the experimental results presented herein is four, however different embodiments may use higher or lower maximum orders.

gᵢ(j) is one of:

φ_{xy}_{ᵢ₋₁}(j);

φ_{xxy}_{ᵢ₋₁}(j,A₁)±D₁δ(j−A₁);

φ_{xxxy}_{ᵢ₋₁}(j,A₁,A₂)±D₁δ(j−A₁)±D₂δ(j−A₂);

φ_{xxxxy}_{ᵢ₋₁}(j,A₁,A₂,A₃)±D₁δ(j−A₁)±D₂δ(j−A₂)±D₃δ(j−A₃). (4)

In Equation (4), the discrete impulse function δ(j−A)=1 if j=A, and equals zero otherwise. A is fixed at one of the values 0, . . . , R. The sign of the δ term is chosen randomly, and D is adjusted to tend to zero as the mean-square of the residual yₜ₋₁(n) approaches zero. For example, D may be set as shown in Equation (5). The nonlinear system to be identified is assumed to have finite memory lasting up to R lags, therefore, g₁(j)=0, j>R.

$$D = \frac{\overline{{y}_{i - 1}^{2} ( n )}}{\overline{{y}^{2} ( n )}} \qquad ( 5 )$$

The overbar denotes time-average over the portion of the series from n=R to n=T.

For cross-correlation orders P that are greater than 1, P−1 of the cross-correlation's arguments are fixed randomly at values A₁, . . . A_{P-1} each in the range 0, . . . , R. Impulses are added or subtracted, as in Equation (4) at locations j=A₁, . . . , A_{P-1}, and the impulses are scaled by Dᵢ, . . . , D_{P-1}. Note that different models may result each time because there are probabilistic elements in the above-described embodiment of the method, e.g. in choice of P, signs of the δ terms, and A₁, . . . , A_{P-1}.

The cross-correlations of the input with the residual are computed over the portion of the series extending from n=R to n=T as shown in Equations (6) in which j, j₁=0, . . . , R, and for i>1 each jᵢ is fixed at a value chosen from 0, . . . , R as in Equation (4).

$${φ}_{{xy}_{i - 1}} ( j ) = \overline{{y}_{i - 1} ( n ) x ( n - j )} = \frac{1}{T - R + 1} {\sum }_{n = R}^{T} {y}_{i - 1} ( n ) x ( n - j ) \\ {φ}_{{xxy}_{i - 1}} ( {j}_{1} , {j}_{2} ) = \frac{1}{T - R + 1} {\sum }_{n = R}^{T} {y}_{i - 1} ( n ) x ( n - {j}_{1} ) x ( n - {j}_{2} ) \\ {φ}_{{xxxy}_{i - 1}} ( {j}_{1} , {j}_{2} , {j}_{3} ) = \frac{1}{T - R + 1} {\sum }_{n = R}^{T} {y}_{i - 1} ( n ) x ( n - {j}_{1} ) x ( n - {j}_{2} ) x ( n - {j}_{3} ) \\ {φ}_{{xxxxy}_{i - 1}} ( {j}_{1} , {j}_{2} , {j}_{3} , {j}_{4} ) = \frac{1}{T - R + 1} {\sum }_{n = R}^{T} {y}_{i - 1} ( n ) x ( n - {j}_{1} ) x ( n - {j}_{2} ) x ( n - {j}_{3} ) x ( n - {j}_{4} ) \qquad ( 6 )$$

However, note that there are many other methods known to one skilled in the art for determining a suitable impulse response gᵢ(j), and the method is not limited to use of slices of cross-correlations as in Equation (4). After determining the impulse response gᵢ(j) of the linear element, the output, uᵢ(n), of the dynamic linear component is calculated with Equation (7). Note that the convolution is calculated over the range n=R, . . . ,T to avoid needing x(n) for n<0.

$${u}_{i} ( n ) = {\sum }_{j = 0}^{R} {g}_{i} ( j ) x ( n - j ) \qquad ( 7 )$$

The signal uᵢ(n) is itself the input to a static nonlinear element in the cascade that is in the form of a polynomial. The output, zᵢ(n), is shown below in Equation (8). Because each cascade consists of a dynamic linear element followed by a static nonlinearity, the output of the static nonlinear element is the cascade output. The polynomial coefficients aₘ defining the polynomial static nonlinearity are found by best fitting the output zᵢ(n) to the current residual yₜ₋₁(n).

$${z}_{i} ( n ) = {\sum }_{m = 0}^{I} {a}_{im} {u}_{i}^{m} ( n ) \qquad ( 8 )$$

In some embodiments, a Fast-Orthogonal Algorithm (FOA) may be applied to find aₘ. FOA uses an orthogonal approach that avoids the need to explicitly create the orthogonal basis functions. Details about FOA are described in Korenberg's article entitled “Identifying nonlinear difference equation and functional expansion representations—the Fast Orthogonal Algorithm” as published in the Annals of Biomedical Engineering 16(1), 123-142, 1988.

Thus, the polynomial coefficients aₘ minimize the mean-square of the new residual over n=R, . . . , T . Therefore, it can be shown that the mean square of the new residual is:

y̅ᵢ̅²̅(̅n̅)̅= y̅ₜ̅₋̅₁̅²̅(̅n̅)̅− z̅ᵢ̅²̅(̅n̅)̅ (9)

Once the parallel cascade model has been identified, the model mean square error (MSE) and % MSE, which are defined below in Equations (10), are calculated. In the equation, y(n) is the actual system output, yᵢ(n) is the residual after adding the i-th cascade, z; (n) is the output of the i-th cascade. The % MSE is the MSE scaled by the variance of the original system output. The overbar still denotes a time average in the range n=R, . . . ,T . % MSE may be used instead of MSE to enable comparison between different time-series data. Suppose that the number of cascades accepted is K. Then

$$MSE = \overline{{[ y ( n ) - {\sum }_{i = 1}^{K} {z}_{i} ( n ) ]}^{2}} = \overline{{y}_{K}^{2} ( n )} , \\ \% MSE = \frac{\overline{{y}_{K}^{2} ( n )}}{\overline{{y}^{2} ( n )} - {( \overline{y ( n )} )}^{2}} \times 100 \% . \qquad ( 10 )$$

Before accepting a given candidate for the i-th cascade, a cascade's reduction of the MSE, divided by the mean square of the current residual, must exceed the threshold constant Th divided by the number of output points T−R+1 used to estimate the cascade. This requirement is shown in Equation (11). Th is set at 4 in the embodiments discussed herein, although other embodiments could use higher or lower values for Th.

$$\overline{{{z}_{i} ( n )}^{2}} > \frac{Th}{T - R + 1} \overline{{{y}_{i - 1} ( n )}^{2}} \qquad ( 11 )$$

This requirement helps to avoid selecting unnecessary cascades that are merely fitting noise. If the criterion is met, then the candidate cascade is accepted. The new residual yᵢ(n) is subsequently calculated as shown in Equation (3), and a candidate for the (i+1)-th cascade is found. If a candidate cascade cannot satisfy this requirement, then it is rejected and a new candidate cascade is constructed and tested against the threshold requirement. This process is repeated until the preset number of rejected cascades has been reached and the algorithm is terminated.

Parallel cascade identification may be terminated when a specified number of cascades have been added. In the embodiments discussed herein, the maximum number C of cascades that can be added to the model was pre-determined. The termination of parallel cascade development may be also made when the MSE has been made sufficiently small, or no remaining candidate cascade can cause a significant reduction in MSE, or a preset maximum number Re of candidate cascades are consecutively rejected (for example, but not limited to 10-1000. Other embodiments may use a fewer or greater number of candidate cascades, e.g., by changing the maximum number of consecutively rejected cascades allowed).

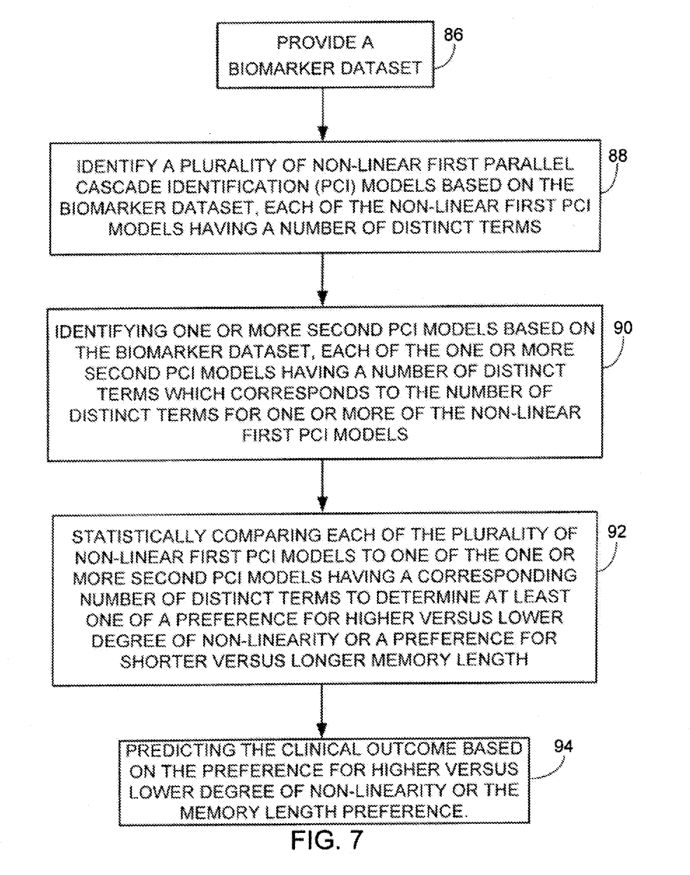

FIG. 7 illustrates another embodiment of a method for predicting a clinical outcome for a patient with congestive heart failure. A biomarker dataset is provided 86. Non-limiting examples of suitable biomarkers have been discussed above, such as, but not limited to ECG data, a metric based on ECG data, an R-R interval, a QT segment, an ST segment, a QRS complex interval, the amplitude of the T wave, a PR interval, the amplitude of the P wave, a direction of a significant axis determined by principal component analysis, and a heart rate. For simplicity, a biomarker dataset derived from ECG signals is discussed in more detail for this embodiment. However, it should be understood that other types of biomarker datasets may be used. If using ECG signals, the ECG signals may be provided from a variety of ECG capture devices as discussed above. The ECG signals may be provided in “real-time” from a subject coupled to an ECG capture device, or the ECG signals may be provided from a database (which should be understood to include memory devices) storing previously obtained ECG signals. The biomarker dataset may optionally be filtered as previously discussed.

A plurality of nonlinear first PCI models are identified 88 based on the biomarker dataset, each of the nonlinear first PCI models having a number of distinct terms. One or more second PCI models are also identified 90 based on the biomarker dataset, each of the one or more second PCI models having a number of distinct terms which corresponds to the number of distinct terms for one or more of the nonlinear first PCI models. In some embodiments, each of the one or more second PCI models may be a substantially linear PCI model based on the biomarker dataset. A substantially linear model 1) may have no nonlinear terms, 2) may have linear and nonlinear terms, provided the highest degree of the terms present is substantially equal to one, or 3) may have only nonlinear terms, provided the highest degree of the nonlinear terms is substantially equal to one. In other embodiments, one or more second PCI models may be nonlinear PCI models.

Each of the plurality of nonlinear first PCI models is statistically compared 92 to one of the one or more second PCI models having a corresponding number of distinct terms to determine a preference for higher versus lower degree of nonlinearity or a preference for shorter versus longer memory length. Each of the nonlinear first PCI models being compared will have a first memory length. Similarly, each corresponding second PCI model in the paired comparison will have a second memory length. Each of the plurality of nonlinear first PCI models will also have its own degree of nonlinearity. In the case where the second PCI models are nonlinear PCI models, each of the one or more second PCI models will have another degree of nonlinearity. In this case, the degree of nonlinearity of each of the plurality of nonlinear first PCI models is preferably (but not necessarily) different from the other degree of nonlinearity of the nonlinear second PCI model to which it is compared. In preferred embodiments, each model in the compared pairs of nonlinear first PCI model and nonlinear second PCI model have a different memory length, such that the first memory length of nonlinear first PCI model is less than the second memory length of the second PCI model.

Various different methods may be used to statistically compare each of the plurality of nonlinear first PCI models to the second PCI model having a corresponding number of distinct terms to determine a preference for higher versus lower degree of nonlinearity or shorter versus longer memory preference. For example, a statistical test such as the Wilcoxon Signed-Ranks test or the MN-Wilcoxon Signed-Ranks test may be used.

If R+1 is the memory length and I is the polynomial degree, then the number of distinct terms M in the Volterra series corresponding to the parallel LN cascade model is calculated according to Equation (12).

$$M = \frac{( R + 1 + I ) !}{( R + 1 ) ! I !} \qquad ( 12 )$$

To determine if nonlinearities are significant in the given data, the % MSE reduction and the number of cascades accepted by a linear model can be compared with those for a nonlinear model having the same number of distinct terms using the Wilcoxon signed-rank test. The approach is explained in the following discussion. Suppose that the memory length is R+1 and the polynomial degree is I. If the polynomial degree is not always the same for each cascade of the PCI model, then consider the maximum degree over all the model's cascades. Using Equation (12), the total number of distinct terms may be calculated. The % MSE reduction and number of cascades accepted would be compared with those for a linear model (i.e. I=1) with memory length M. This will give a pair of nonlinear % MSE reduction and linear % MSE reduction, and another pair of nonlinear number of cascades accepted and linear number of cascades accepted. In addition, suppose that both first and second PCI models in each pair are nonlinear, but with a different order of nonlinearity. We can still compare pairs of higher-order nonlinear and lower-order nonlinear models with the same number of distinct terms, as to number of cascades accepted and % MSE reduction. In other cases, suppose that both first and second PCI models in each pair have the same order of nonlinearity, but have different memory lengths. An example is discussed below in “Second nonlinear model pair test: p=2”. We can still compare pairs of longer and shorter memory models with the same number of distinct terms, as to number of cascades accepted and % MSE reduction.

Instead of a linear model, it's easier and more reasonable to fit a parallel cascade with I=1 using the same threshold constant Th regulating the minimum MSE reduction required for a candidate cascade to be accepted as for nonlinear models, and the same number of candidates tested. In that case use memory length M−1 for I=1 model, since there's also a constant term. Due to this constant term, for convenience the I=1 model will henceforth be referred to as a “first order Volterra series” and sometimes as a “linear” model, but it is not in fact linear except in the unlikely event of the estimated constant equaling zero. Also, sometimes we will use “degree” instead of “order”.

These pairs of first and second PCI models can be made for a fixed I (say, I=2, in this embodiment) by varying R+1. The difference between higher-order nonlinear and first order (I=1) models can be considered to determine if it is significant. Then, the process may be repeated for a different I, and in this way it may be determined for which values of I do nonlinear models outperform I=1 models. Alternatively, the pairs may be made up for fixed R+1 by varying I, or by varying both R+1 and I. The latter alternatives provide examples of when the different higher order nonlinear models do not all have the same degree of nonlinearity in every pair, so we may not be determining a degree of nonlinearity but rather a preference for higher versus lower degree of nonlinearity, where lower degree can include the linear and I=1 cases. If nonlinearities are important, then the nonlinear model should consistently have a larger % MSE reduction and more cascades accepted than the I=1 model with the same number of distinct terms. In particular, a Wilcoxon signed-rank test can be used to see if nonlinear models consistently have larger % MSE reductions, or number of cascades accepted, than I=1 models with the same number of distinct terms.

Note that the nonlinear model, say with I=2, is fit over the identical portion of the record as the model with I=1, i.e., if the I=1 model has memory length R+1, then fitting the I=1 model uses the R+1^{th} to T+1^{th} output points. Therefore, in this embodiment, the I=2 model is fit using these same output points. The denominator T−R+1 in Equation (11) refers to the number of output points used in the identification. It should be the same number when comparing the I=1 model with the I=2 model.

The Wilcoxon signed-rank test is a non-parametric test for the significance of the difference between the distributions of two non-independent samples involving repeated measures or matched pairs X_{A}, X_{B}. The Wilcoxon test begins by taking the absolute value of each instance of X_{A}−X_{B}. The absolute values of the differences are then ranked from lowest to highest, with tied ranks included where appropriate. The positive or negative sign that had been removed from the X_{A}−X_{B} difference is now attached to each rank. The sum, W, of the signed ranks, is then calculated. The standard deviation of the sampling distribution of W is equal to:

$${σ}_{w} = sqrt [ \frac{Q ( Q + 1 ) ( 2 Q + 1 )}{6} ] \qquad ( 13 )$$

where Q is the number of pairs X_{A}, X_{B} after discarding cases where X_{A}=X_{B}.

The z-ratio for the Wilcoxon sinned-rank test is:

$$z = \frac{W - 0.5}{{σ}_{W}} \qquad ( 14 )$$

The table of critical values of z (for the unit normal distribution) can be used to see whether the observed value of z is significant beyond a specified level.

The MN-Wilcoxon signed-rank test is based on the Wilcoxon signed-rank test. In order to see if nonlinear models for a given time series are significantly different from “linear” (I=1) models with the same number of terms, the % MSE reduction, m, and the number of cascades accepted, n, can be incorporated into a single measure when using the Wilcoxon signed ranks test by using the product mn in place of m or n. This may consistently obtain a better level of significance in some applications and is referred to as the MN-Wilcoxon signed-rank test.

When PCI is applied to an input/output pair, as just one example in embodiment with first I=1 and then I=2, two pairs of % MSE reduction (m_lin and m_nl) and the number of cascades accepted (n_lin and n_nl) are computed. After calculating the product of m_lin and n_lin, and also the product of m_nl and n_nl , the Wilcoxon signed-rank test is applied under the alternative hypothesis that the nonlinearity is more significant. Comparing the calculated z value with the critical z value provides the final decision on whether nonlinearity can be detected. In the experimental results discussed herein, a delay of one lag is always used to create the input signal from the given time series, which served as the corresponding output in its undelayed form. However, it should be understood that other delays may be used in different embodiments.

Referring to FIG. 7 again, once the statistical comparison 92 has been completed, a clinical outcome can be predicted 94 based on the preference for higher versus lower degree of nonlinearity. Experiments have found that preference for higher degrees of nonlinearity are indicative that a patient is unlikely to survive and therefore by this criterion may be considered a high-risk congestive heart failure patient. Experiments have also shown that a preference for shorter rather than longer memory length models, even when all models have the same degree of nonlinearity, is predictive of a high-risk congestive heart failure patient. Thus while some examples and Figures have for simplicity focused on determining whether there is a preference for higher rather than lower degree nonlinearities, they can also readily be modified to detect a preference for shorter versus longer memory length models.

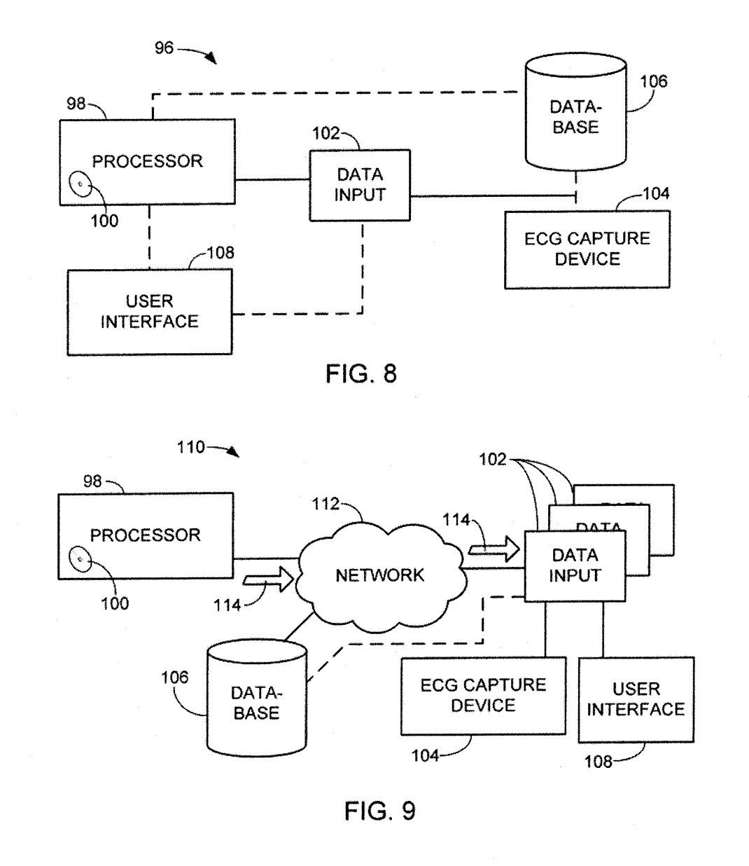

FIG. 8 schematically illustrates an embodiment of a congestive heart failure (CHF) prediction system 96 for predicting a clinical outcome for a patient with congestive heart failure. The system 96 has a processor 98 which is configured to predict the clinical outcome based on a preference for higher versus lower degree of nonlinearity determined from a statistical comparison of a plurality of nonlinear first PCI models and at least one second PCI model which are identified to approximate a biomarker dataset based on ECG data. Embodiments of suitable processes and method steps to make the prediction of clinical outcome have already been discussed above. The processor 98 may be a computer executing machine readable instructions which are stored on a computer readable medium 100, such as, but not limited to a CD, a magnetic tape, an optical drive, a DVD, a hard drive, a flash drive, a memory card, a memory chip, or any other computer readable medium. The processor 98 may alternatively or additionally include a laptop, a microprocessor, an application-specific integrated circuit (ASIC), digital components, analog components, or any combination and/or plurality thereof. The processor 98 may be a stand-alone unit, or it may be a distributed set of devices.

A data input 102 is coupled to the processor 98 and configured to provide the processor with ECG biomarker data. An ECG capture device 104 may optionally be coupled to the data input 102 to enable the live capture of ECG biomarker data. Examples of ECG capture devices include, but are not limited to, a twelve-lead ECG device, an eight-lead ECG device, a two lead ECG device, a Holter device, a bipolar ECG device, and a uni-polar ECG device. Similarly, a database 106 may optionally be coupled to the data input 102 to provide previously captured ECG signal biomarker data to the processor 98. Database 106 can be as simple as a memory device holding raw data or formatted files, or database 106 can be a complex relational database. Depending on the embodiment, none, one, or multiple databases 106 and/or ECG capture devices 104 may be coupled to the data input 102. The ECG capture device 104 may be coupled to the data input 102 by a wired connection, an optical connection, or by a wireless connection. Suitable examples of wireless connections may include, but are not limited to, RF connections using an 802.11x protocol or the Bluetooth® protocol. The ECG capture device 104 may be configured to transmit data to the data input 102 only during times which do not interfere with data measurement times of the ECG capture device 104. If interference between wireless transmission and the measurements being taken is not an issue, then transmission can occur at any desired time. Furthermore, in embodiments having a database 106, the processor 98 may be coupled to the database 106 for storing results or accessing data by bypassing the data input 102.

The system 96 also has a user interface 108 which may be coupled to either the processor 98 and/or the data input 102. The user interface 108 can be configured to display the ECG signal biomarker data, a graph of one or more of the first and second PCI models, the preference for higher versus lower degree of nonlinearity determined in the statistical comparison, and/or the predicted clinical outcome. The user interface 108 may also be configured to allow a user to select ECG signal biomarker data from a database 106 coupled to the data input 102, or to start and stop collecting data from an ECG capture device 104 which is coupled to the data input 102.

FIG. 9 schematically illustrates another embodiment of a congestive heart failure (CHF) prediction system 110 for predicting a clinical outcome for a patient with congestive heart failure. In this embodiment, the processor 98 is set-up to be a remote processor which is coupled to the data input 102 over a network 112. The network 112 may be a wired or wireless local area network (LAN or WLAN) or the network 112 may be a wired or wireless wide area network (WAN, WWAN) using any number of communications protocols to pass data back and forth. Having a system 110 where the processor 98 is located remotely allows multiple client side data inputs 102 to share the resources of the processor 98. ECG signal biomarkers may be obtained by the data input 102 from a database 106 and/or an ECG capture device 104 under the control of a user interface 108 coupled to the data input 102. The ECG signal biomarker data may then be transferred over the network 112 to the processor 98 which can then predict the clinical outcome based on a preference for higher versus lower degree of nonlinearity determined from a statistical comparison of a plurality of nonlinear first PCI models and at least one second PCI model which are identified to approximate the biomarker dataset and transmit data signals 114 having the predicted clinical outcome to the client side. Such data transmissions may take place over a variety of transmission media, such as wired cable, optical cable, and air. In this embodiment, the remote processor 98 can be used to help keep the cost of the client-side hardware down, and can facilitate any upgrades to the processor or the instructions being carried out by the processor, since there is a central upgrade point.

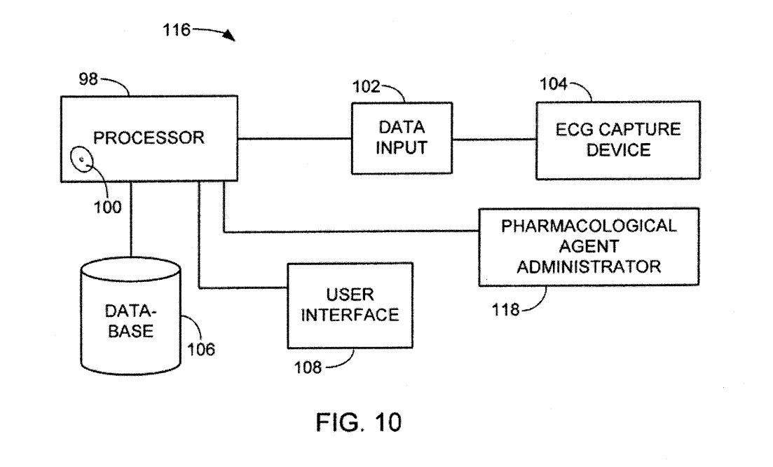

FIG. 10 schematically illustrates a further embodiment of a congestive heart failure (CHF) prediction system 116 for predicting a clinical outcome for a patient with congestive heart failure. In this embodiment, a data input 102, a user interface 108, and a database 106 are coupled to the processor 98. An ECG capture device 104 is coupled to the data input 102. The system 116 also has a pharmacological agent administrator 118 which is coupled to the processor 98. The pharmacological agent administrator 118 may be configured to administer a pharmacological agent to a patient when enabled by the processor 98. The system 116 of FIG. 10, and its equivalents, may be useful in automating the analysis of the effects of pharmacological agents on patients with congestive heart failure. A baseline clinical outcome may be predicted for a patient with congestive heart failure. Then, the processor can instruct the pharmacological agent administrator 118 to administer a pharmacological agent. Then, a post-administration clinical outcome may be predicted for the patient. An effect of the pharmacological agent on the clinical outcome for the congestive heart failure patient may be determined based on a comparison of the baseline predicted clinical outcome and the post-administration predicted clinical outcome.

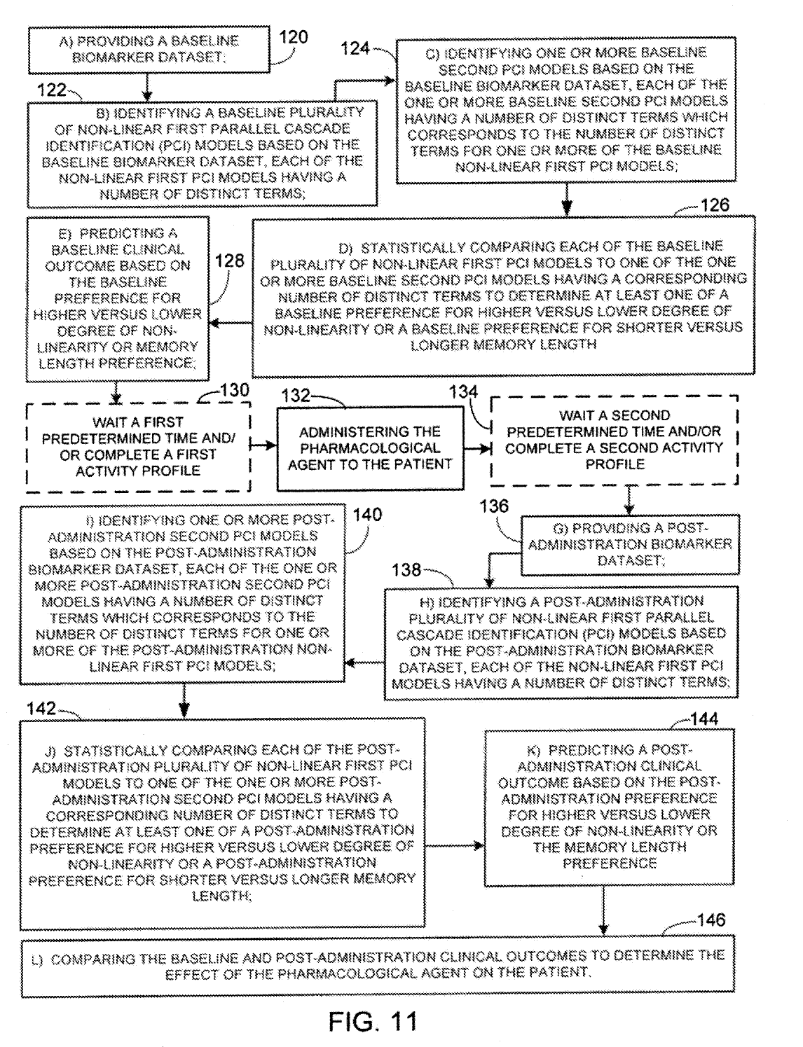

FIG. 11 illustrates one embodiment of a method for determining an effect of a pharmacological agent. A baseline biomarker dataset is provided 120. Suitable types of biomarker datasets and their provision through either real-time capture or recall from a database have been discussed above. A baseline plurality of nonlinear first parallel cascade identification (PCI) models are identified 122 based on the baseline biomarker dataset. Each of the baseline nonlinear first PCI models has a number of distinct terms. One or more baseline second PCI models are identified 124 based on the baseline biomarker dataset. Each of the one or more baseline second PCI models has a number of distinct terms which corresponds to the number of distinct terms for one or more of the baseline nonlinear first PCI models. Each of the baseline plurality of nonlinear first PCI models is statistically compared 126 to one of the one or more baseline second PCI models having a corresponding number of distinct terms to determine at least one of a baseline preference for higher versus lower degree of nonlinearity and a baseline preference for shorter versus longer memory length. Suitable examples of PCI models and their statistical comparison to determine a preference for higher versus lower degree of nonlinearity or preference for shorter versus longer memory length have been discussed above. A baseline clinical outcome is predicted 128 based on the baseline preference for higher versus lower degree of nonlinearity or the baseline preference for shorter versus longer memory length. Optionally, the process can then wait 130 for a first predetermined time and/or for the patient to complete a first activity profile, such as, for example, eating, walking, sleeping, running, or resting.

The pharmacological agent may then be administered 132 to the patient. Optionally, the process can then wait 134 for a second predetermined time and/or for the patient to complete a second activity profile, such as, for example, eating, walking, sleeping, running, or resting. A post-administration biomarker dataset is provided 136. Suitable types of biomarker datasets and their provision through either real-time capture or recall from a database have been discussed above. A post-administration plurality of nonlinear first parallel cascade identification (PCI) models are identified 138 based on the post-administration biomarker dataset. Each of the post-administration nonlinear first PCI models has a number of distinct terms. One or more post-administration second PCI models are identified 140 based on the post-administration biomarker dataset. Each of the one or more post-administration second PCI models has a number of distinct terms which corresponds to the number of distinct terms for one or more of the post-administration nonlinear first PCI models. Each of the post-administration plurality of nonlinear first PCI models is statistically compared 142 to one of the one or more post-administration second PCI models having a corresponding number of distinct terms to determine at least one of a post-administration preference for higher versus lower degree of nonlinearity and a post-administration preference for shorter versus longer memory length. Suitable examples of PCI models and their statistical comparison to determine a preference for higher versus lower degree of nonlinearity or a preference for shorter versus longer memory length have been discussed above. A post-administration clinical outcome is predicted 144 based on the post-administration preference for higher versus lower degree of nonlinearity or the post-administration preference for shorter versus longer memory length. Finally, the baseline and post-administration clinical outcomes are compared 146 to determine the effect of the pharmacological agent on the patient. Either 1) an increase in preference for higher versus lower degree nonlinearity from the baseline to the post-administration determinations or 2) an increase in preference for shorter versus longer memory length from the baseline to the post-administration determinations might indicate the pharmacological agent could have a detrimental effect on a congestive heart failure patient. Alternatively, either 1) a decrease in preference for higher versus lower degree of nonlinearity from the baseline to the post-administration determinations or 2) a decrease in preference for shorter versus longer memory length from the baseline to the post-administration determinations might indicate the pharmacological agent would have a helpful effect on a congestive heart failure patient.

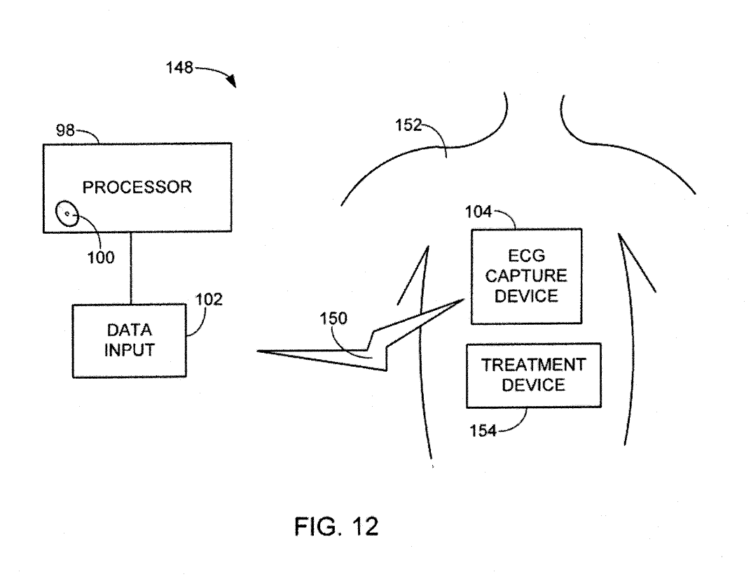

FIG. 12 schematically illustrates another embodiment of a congestive heart failure (CHF) prediction system 148 for predicting a clinical outcome for a patient with congestive heart failure. Similar to other embodiments, the system has a processor 98 which is coupled to a data input 102. An ECG capture device 104 is coupled 150 to the data input 102. The coupling 150 may be wired or wireless. The ECG capture device 104 is configured so that at least a portion of the ECG capture device 104 is implantable in a subject's body 152. The processor 98 and the data input 102 are external to the subject's body 152 in this embodiment, however, in other embodiments, the processor 98 and/or the data input 102 could be partially or entirely implanted in the subject's body 152. The system 148 of FIG. 12 may optionally have a treatment device 154 coupled to the processor 98. In this case, the processor 98 may be configured to activate the treatment device 154 to attempt to correct or forestall an unfavorable clinical outcome predicted for the patient. Suitable examples of treatment devices 154 include, but are not limited to, a pharmacological agent administrator and a defibrillator. The treatment device 154 may also be partially or completely implanted inside of the subject 152.

Methods for predicting a clinical outcome for a patient with congestive heart failure (CHF), such as those discussed above, have been used in validations with encouraging results to separate low-risk CHF patients from high-risk CHF patients:

### Experimental Results:

PCI was used to distinguish R-R wave intervals of CHF patients who died from those of patients who survived in a 5-year study.

### Data Source

Two heartbeat datasets of congestive heart failure patients are used in the present study. Both datasets were kindly provided by Dr. Chi-Sang Poon at the Massachusetts Institute of Technology and Dr. Mark T. Kearney of the University of Leeds, and are described in detail below.

The smaller dataset included 49 patients' R-R wave intervals in seconds (22 died and 27 survived during the 5-year study), and is used as a first test set. The larger dataset included 352 patients' R-R wave intervals in seconds (121 died and 231 survived during the study), and is used as a second test set to see whether the results obtained are consistent with those for the first test set. All the data were recorded from 1994 to 1995, and the 5-year study was completed in 2000. None of the data were preprocessed, and no outliers were removed.

### Study Samples in the Smaller Test Dataset

The baseline characteristics of 49 study subjects in the smaller set are shown in Table 1. The mean age of the study subjects is 62.2±10.1 years old (range: 29 to 86 years old), and all of the subjects have congestive heart failure. Table 2 displays the characteristics of 22 patients who died during the 5-year study. The characteristics of 27 patients who survived during the 5-year study are shown in Table 3. Of these 49 patients, 40 patients had ischemic heart disease (IHD), 6 patients had cardiomyopathy, 1 patient had heart valve disease, 1 patient had hypertension, and 1 had other heart disease. Causes of death among the 22 dead patients included: 5 patients died suddenly, 7 patients died because of progressive heart failure, 3 patients' death are other cardiovascular death, and the remaining 7 patients died due to non-cardiovascular disease.

TABLE 1
Baseline characteristics of the smaller test set

| | Deceased | Surviving |
|---|---|---|
| | patients (n = 22) | patients (n = 27) |
| Men | 19 | 16 |
| Women | 3 | 11 |
| Age (mean ± SD) | 62.8 ± 7.9 | 61.7 ± 11.7 |

TABLE 2
Characteristics of 22 deceased patients in the smaller test set

| Study | | | NYHA | death | Study | | | NYHA | death |
|---|---|---|---|---|---|---|---|---|---|
| No. | Age/sex | diagnose | class | cause | No. | Age/sex | Diagnose | class | cause |
| HF17 | 66/F | IHD | II | 2 | HF270 | 54/F | IHD | II | 1 |
| HF565 | 63/M | C | II | 4 | HF41 | 74/M | IHD | II | 4 |
| HF71 | 50/M | IHD | III | 3 | HF168 | 61/M | IHD | II | 2 |
| HF202 | 54/M | IHD | IV | 1 | HF593 | 49/M | IHD | III | 1 |
| HF10 | 72/M | IHD | II | 2 | HF392 | 52/M | IHD | III | 1 |
| HF30 | 56/M | IHD | II | 4 | HF606 | 74/M | IHD | II | 2 |
| HF383 | 64/M | IHD | II | 4 | HF181 | 68/M | IHD | III | 3 |
| HF056 | 67/M | IHD | II | 4 | HF400 | 58/M | IHD | II | 3 |
| HF266 | 74/M | C | III | 2 | HF555 | 62/M | IHD | II | 4 |
| HF442 | 59/M | IHD | III | 2 | HF54 | 65/M | IHD | IV | 2 |
| HF518 | 71/F | O | III | 1 | HF585 | 69/M | IHD | II | 4 |

IHD = Ischemic heart disease;
C = cardiomyopathy;
O = others;
NYHA class = New York Heart Association functional class.
Cause of death: 1, sudden death; 2, progressive heart failure; 3, other cardiovascular death; 4, non-cardiovascular death.

TABLE 3
Characteristics of 27 surviving patients in the smaller test set

| Study | | diag- | NYHA | Study | Age/ | | NYHA |
|---|---|---|---|---|---|---|---|
| No. | Age/sex | nose | class | No. | sex | diagnose | class |
| HF369 | 74/M | IHD | II | HF381 | 63/F | IHD | II |
| HF569 | 65/F | IHD | II | HF253 | 63/F | IHD | II |
| HF373 | 86/F | IHD | II | HF471 | 69/M | IHD | II |
| HF377 | 63/M | H | II | HF268 | 55/F | V | II |
| HF196 | 69/M | IHD | II | HF100 | 68/F | IHD | II |
| HF522 | 58/M | IHD | II | HF188 | 59/M | IHD | III |
| HF408 | 29/M | C | II | HF608 | 61/M | IHD | II |
| HF222 | 74/F | IHD | II | HF5 | 57/M | IHD | III |
| HF391 | 52/M | IHD | II | HF559 | 72/F | IHD | IV |
| HF247 | 56/M | C | III | HF419 | 68/F | IHD | II |
| HF082 | 38/F | C | II | HF215 | 71/M | IHD | II |
| HF105 | 66/M | IHD | II | HF451 | 58/M | IHD | III |
| HF282 | 45/M | C | II | HF124 | 71/F | IHD | III |
| HF234 | 55/M | IHD | II | | | | |

IHD = Ischemic heart disease;
C = cardiomyopathy;
H = hypertension;
V = heart valve disease;
NYHA class = New York Heart Association functional class.

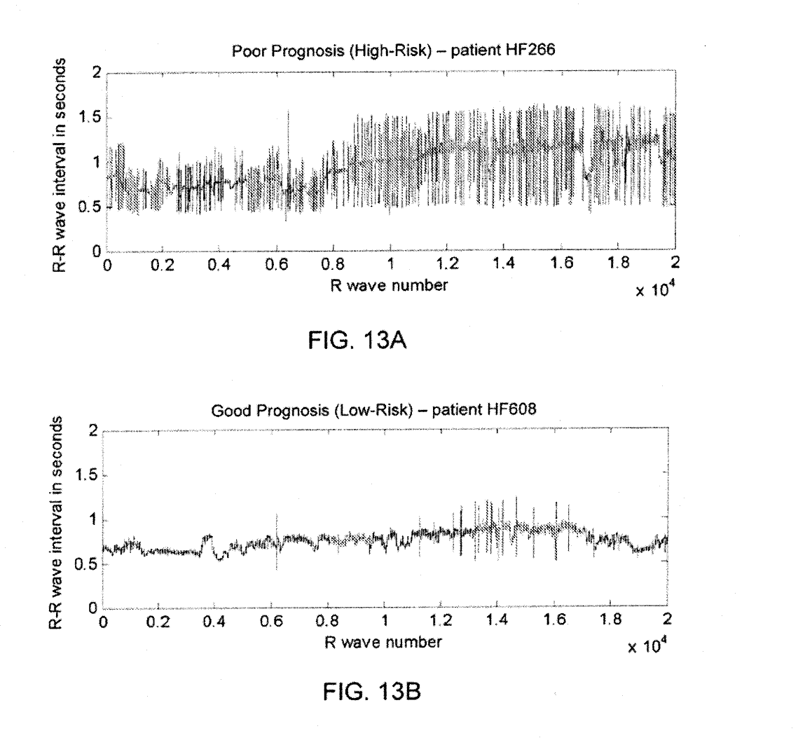

FIG. 13A displays a representative heartbeat series from a CHF patient with a poor prognosis (high-risk) who ultimately died in the 5-year study. FIG. 13B displays a representative heartbeat series from a CHF patient with a good prognosis (low-risk) who survived in the study. The Y-axis represents the R-R wave interval in seconds between two adjacent R peaks. The X-axis represents the number of R peaks. The surviving CHF patient of FIG. 13B shows decreased complexity and increased predictability, which may reflect less likelihood of detecting nonlinearity. These two figures illustrate the extreme cases of surviving patient and deceased patient.

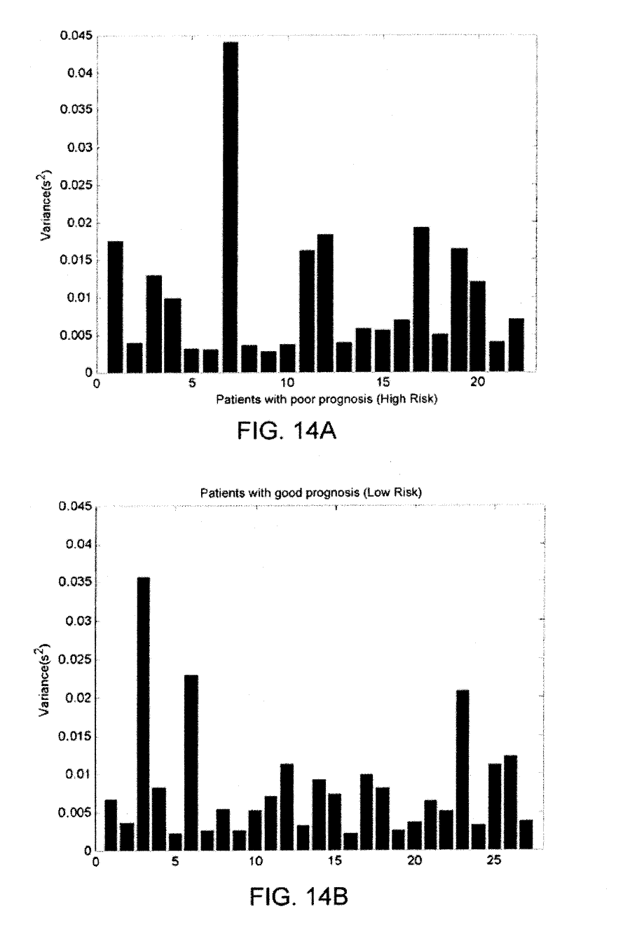

The variance of R-R wave intervals in 22 CHF patients with poor prognosis (who happened to end up dying in this study) and 27 CHF patients with good prognosis (who survived in this study) is illustrated in FIGS. 14A and 14B, respectively. Each patient is represented by a bar whose height indicates that patient's variance. A slightly decreased variability is found in the surviving CHF patients of FIG. 14B.

### Study Samples in the Larger Test Dataset

The characteristics of 352 study subjects in the larger test set are illustrated in Table 4. The mean age of the study subjects is 62.4±9.7 years old (range: 19 to 79 years old).

TABLE 4
Baseline characteristics of the larger data set

| | Deceased patients | Surviving |
|---|---|---|
| | (n = 121) | patients (n = 231) |
| Men | 97 | 172 |
| Women | 24 | 59 |
| Age (mean ± SD) | 63.6 ± 9.9 | 61.7 ± 9.5 |

Tables 5 and 6 show the characteristics of 121 deceased patients and 231 surviving patients in the larger dataset respectively. Of the 352 patients in total, 272 patients had ischemic heart disease (IHD); 42 patients had cardiomyopathy, 21 patients had heart valve disease, 14 patients had hypertension, 2 patients had congenital heart disease, and 1 patient had other heart disease. Causes of death among the dead patients included sudden death in 42, progressive heart failure in 49, other cardiovascular death in 14, non-cardiovascular death in 16.

TABLE 5
Characteristics of 121 deceased patients in the larger test set

| | | | NYHA | death | | | | NYHA | death |
|---|---|---|---|---|---|---|---|---|---|
| study No. | Age/sex | Diagnosis | class | cause | study No. | Age/sex | Diagnosis | class | cause |
| HF101 | 63/M | IHD | III | 2 | HF241 | 64/M | IHD | II | 2 |
| HF104 | 73/F | IHD | III | 1 | HF244 | 80/M | IHD | II | 2 |
| HF128 | 45/M | C | II | 1 | HF248 | 70/F | IHD | II | 2 |
| HF131 | 60/M | IHD | II | 1 | HF249 | 68/M | IHD | II | 2 |
| HF132 | 62/F | IHD | III | 1 | HF250 | 55/M | IHD | II | 1 |
| HF135 | 61/F | C | III | 2 | HF256 | 73/M | IHD | II | 1 |
| HF136 | 60/M | IHD | III | 1 | HF257 | 64/M | IHD | III | 4 |
| HF139 | 73/M | IHD | II | 2 | HF259 | 66/M | V | III | 2 |
| HF150 | 68/M | IHD | III | 1 | HF260 | 69/M | V | II | 4 |
| HF155 | 72/M | IHD | II | 4 | HF263 | 69/M | O | II | 1 |
| HF16 | 50/F | IHD | III | 1 | HF264 | 72/M | IHD | III | 2 |
| HF161 | 59/F | C | III | 3 | HF271 | 71/M | IHD | III | 4 |
| HF162 | 55/F | C | III | 1 | HF277 | 46/M | IHD | III | 2 |
| HF170 | 55/M | IHD | II | 1 | HF279 | 70/F | IHD | III | 1 |
| HF171 | 72/M | C | II | 2 | HF292 | 72/F | IHD | III | 2 |
| HF180 | 80/F | V | II | 3 | HF294 | 44/M | IHD | III | 1 |
| HF182 | 63/M | IHD | II | 1 | HF 295 | 51/M | IHD | III | 2 |
| HF189 | 58/F | IHD | II | 2 | HF299 | 66/M | C | II | 2 |
| HF190 | 67/M | V | II | 3 | HF310 | 62/F | IHD | II | 1 |
| HF198 | 57/M | IHD | III | 3 | HF317 | 56/M | C | II | 1 |
| HF201 | 70/M | IHD | III | 2 | HF032 | 46/M | IHD | II | 1 |
| HF204 | 64/M | IHD | II | 4 | HF320 | 54/M | IHD | II | 1 |
| HF205 | 55/M | IHD | II | 4 | HF321 | 60/M | IHD | II | 1 |
| HF21 | 71/M | IHD | III | 4 | HF 328 | 61/M | IHD | III | 3 |
| HF216 | 60/F | C | III | 2 | HF329 | 67/M | IHD | III | 2 |
| HF219 | 80/M | IHD | III | 1 | HF 330 | 59/F | IHD | II | 2 |
| HF220 | 70/M | IHD | II | 1 | HF333 | 71/F | IHD | III | 2 |
| HF223 | 67/F | V | II | 1 | HF337 | 65/M | IHD | II | 2 |
| HF229 | 71/M | IHD | III | 4 | HF338 | 75/M | V | III | 2 |
| HF230 | 71/M | IHD | II | 3 | HF346 | 67/M | IHD | III | 2 |
| HF237 | 71/M | IHD | III | 2 | HF349 | 53/M | IHD | III | 1 |
| HF239 | 79/M | IHD | III | 1 | HF352 | 52/F | IHD | III | 2 |
| HF36 | 66/F | IHD | II | 2 | HF390 | 67/F | IHD | II | 1 |
| HF364 | 72/M | IHD | III | 2 | HF393 | 72/M | IHD | III | 3 |
| HF370 | 70/M | V | II | 4 | HF397 | 58/M | IHD | III | 3 |
| HF375 | 67/M | IHD | II | 1 | HF402 | 43/M | IHD | II | 1 |
| HF378 | 61/M | IHD | III | 1 | HF410 | 54/M | IHD | III | 3 |
| HF38 | 69/M | IHD | II | 4 | HF42 | 55/M | IHD | III | 1 |
| HF385 | 69/M | IHD | III | 2 | HF420 | 74/M | IHD | II | 3 |
| HF389 | 57/M | IHD | III | 2 | HF428 | 71/M | IHD | III | 2 |
| HF 39 | 73/M | IHD | III | 2 | HF433 | 49/M | IHD | I | 2 |
| HF439 | 73/F | IHD | IV | 2 | HF479 | 61/M | IHD | III | 2 |
| HF22 | 69/M | IHD | III | 2 | HF48 | 64/M | IHD | II | 2 |
| HF440 | 66/M | IHD | II | 2 | HF481 | 69/M | IHD | II | 2 |
| HF441 | 72/M | IHD | III | 4 | HF489 | 71/M | IHD | III | 1 |
| HF445 | 63/M | IHD | II | 2 | HF491 | 65/F | V | II | 1 |
| HF449 | 55/M | IHD | III | 4 | HF492 | 62/M | IHD | III | 1 |
| HF453 | 19/M | C | II | 1 | HF494 | 73/F | V | II | 1 |
| HF46 | 54/M | V | II | 2 | HF499 | 69/M | IHD | III | 2 |
| HF463 | 57/M | C | II | 1 | HF500 | 52/M | IHD | II | 3 |
| HF47 | 71/M | IHD | II | 2 | HF514 | 51/M | IHD | III | 3 |
| HF516 | 44/M | IHD | II | 2 | HF591 | 62/M | IHD | III | 2 |
| HF539 | 59/M | IHD | II | 4 | HF609 | 49/M | C | II | 4 |
| HF547 | 75/M | IHD | III | 2 | HF62 | 73/M | V | II | 2 |
| HF548 | 75/M | IHD | II | 1 | HF68 | 77/M | IHD | III | 2 |
| HF549 | 76/M | IHD | III | 4 | HF79 | 67/M | V | II | 4 |
| HF550 | 57/M | IHD | III | 1 | HF81 | 66/F | V | I | 3 |
| HF570 | 59/M | IHD | II | 1 | HF83 | 76/M | IHD | III | 1 |
| HF578 | 65/M | IHD | II | 1 | HF84 | 75/M | V | II | 2 |
| HF583 | 51/M | IHD | III | 1 | HF9 | 57/F | IHD | III | 3 |
| HF099 | 78/M | IHD | III | 3 | | | | | |

IHD = Ischemic heart disease;
C = cardiomyopathy;
O = others;
H = hypertension;
V = heart valve disease;
NYHA class = New York Heart Association functional class
Cause of death: 1, sudden death; 2, progressive heart failure; 3, other cardiovascular death; 4, non-cardiovascular death

TABLE 6
Characteristics of 231 surviving patients in the larger test set

| study | | diag- | NYHA | study | Age/ | | NYHA |
|---|---|---|---|---|---|---|---|
| No. | Age/sex | nose | class | No. | sex | diagnose | class |
| HF12 | 54/F | IHD | II | HF144 | 74/M | IHD | III |
| HF122 | 57/F | C | III | HF145 | 48/M | IHD | III |
| HF125 | 63/M | IHD | III | HF147 | 58/M | IHD | III |
| HF129 | 65/M | IHD | III | HF148 | 60/M | IHD | II |
| HF133 | 64/F | IHD | III | HF153 | 71/F | H | II |
| HF134 | 59/M | IHD | II | HF151 | 66/M | IHD | II |
| HF138 | 59/M | IHD | III | HF152 | 46/M | IHD | III |
| HF142 | 58/M | IHD | III | HF15 | 65/M | IHD | II |
| HF143 | 64/M | IHD | III | HF160 | 53/F | IHD | II |
| HF163 | 45/M | C | II | HF283 | 70/F | IHD | II |
| HF164 | 56/M | IHD | II | HF284 | 62/M | IHD | II |
| HF165 | 65/M | IHD | III | HF285 | 67/F | H | II |
| HF166 | 57/M | IHD | III | HF290 | 49/M | IHD | II |
| HF167 | 57/M | IHD | III | HF291 | 63/F | IHD | II |
| HF169 | 72/M | IHD | II | HF293 | 66/M | IHD | III |
| HF172 | 59/M | IHD | II | HF296 | 34/M | C | I |
| HF175 | 55/M | IHD | III | HF298 | 69/F | IHD | III |
| HF178 | 61/F | IHD | II | HF3 | 74/M | IHD | III |
| HF179 | 62/M | IHD | I | HF301 | 46/M | IHD | II |
| HF183 | 64/M | IHD | II | HF302 | 42/M | C | II |
| HF184 | 70/F | IHD | III | HF304 | 70/M | IHD | II |
| HF186 | 78/F | H | II | HF307 | 60/M | IHD | II |
| HF187 | 66/M | IHD | II | HF309 | 75/F | IHD | II |
| HF191 | 54/M | IHD | II | HF311 | 78/F | IHD | III |
| HF192 | 50/M | IHD | II | HF312 | 60/M | IHD | II |
| HF197 | 62/F | IHD | II | HF313 | 74/M | IHD | II |
| HF20 | 71/M | IHD | II | HF315 | 63/M | IHD | II |
| HF203 | 76/M | C | II | HF316 | 63/M | IHD | II |
| HF209 | 73/M | IHD | III | HF318 | 62/F | H | II |
| HF212 | 67/M | IHD | III | HF319 | 59/F | C | II |
| HF218 | 63/M | IHD | II | HF324 | 75/M | IHD | II |
| HF224 | 61/M | IHD | III | HF325 | 26/F | V | II |
| HF225 | 60/M | IHD | II | HF327 | 58/M | IHD | III |
| HF231 | 58/M | IHD | II | HF33 | 58/M | IHD | II |
| HF236 | 74/F | H | II | HF342 | 61/M | IHD | II |
| HF238 | 69/M | IHD | II | HF332 | 52/M | IHD | II |
| HF246 | 59/F | IHD | II | HF334 | 46/M | IHD | II |
| HF25 | 66/F | IHD | II | HF335 | 65/M | IHD | III |
| HF251 | 55/M | C | II | HF341 | 56/M | IHD | II |
| HF252 | 60/M | IHD | II | HF331 | 56/M | IHD | I |
| HF254 | 77/F | C | II | HF344 | 68/M | IHD | II |
| HF258 | 63/M | IHD | III | HF347 | 68/M | IHD | II |
| HF26 | 75/M | IHD | III | HF348 | 56/M | IHD | III |
| HF261 | 52/M | IHD | II | HF350 | 64/M | C | III |
| HF262 | 31/F | C | II | HF353 | 59/F | IHD | II |
| HF267 | 61/M | IHD | II | HF355 | 55/M | IHD | II |
| HF269 | 58/M | C | III | HF358 | 66/M | IHD | II |
| HF27 | 54/M | IHD | II | HF360 | 55/M | IHD | II |
| HF272 | 64/M | IHD | II | HF362 | 58/M | IHD | III |
| HF274 | 56/F | IHD | II | HF363 | 62/M | IHD | II |
| HF275 | 63/M | IHD | III | HF366 | 69/M | C | II |
| HF276 | 71/F | IHD | III | HF37 | 50/M | C | II |
| HF278 | 74/M | H | II | HF376 | 70/M | IHD | II |
| HF28 | 51/F | IHD | II | HF379 | 69/M | IHD | II |
| HF280 | 65/M | IHD | III | HF382 | 54/M | C | II |
| HF384 | 69/M | IHD | II | HF472 | 69/M | IHD | II |
| HF394 | 65/M | IHD | II | HF474 | 68/M | IHD | II |
| HF387 | 60/F | IHD | II | HF475 | 45/M | IHD | II |
| HF388 | 70/M | IHD | II | HF476 | 48/M | C | III |
| HF386 | 71/M | IHD | III | HF478 | 74/M | IHD | II |
| HF395 | 63/F | IHD | II | HF485 | 67/M | IHD | II |
| HF396 | 78/F | V | II | HF486 | 71/M | H | II |
| HF398 | 49/F | IHD | III | HF487 | 61/M | IHD | II |
| HF399 | 62/F | IHD | II | HF493 | 63/F | IHD | III |
| HF4 | 47/F | IHD | III | HF495 | 70/M | IHD | III |
| HF401 | 59/M | IHD | III | HF496 | 70/M | IHD | II |
| HF403 | 68/M | IHD | II | HF497 | 62/M | IHD | II |
| HF405 | 75/M | C | III | HF50 | 71/F | C | II |
| HF52 | 43/F | IHD | III | HF530 | 59/M | IHD | II |
| HF406 | 51/M | IHD | III | HF501 | 70/M | IHD | II |
| HF407 | 66/M | IHD | II | HF511 | 63/F | H | II |
| HF409 | 61/F | H | II | HF505 | 61/F | IHD | II |
| HF411 | 48/M | IHD | II | HF506 | 72/M | H | II |
| HF412 | 59/M | C | II | HF507 | 71/F | IHD | II |
| HF413 | 69/F | CO | II | HF51 | 69/M | IHD | III |
| HF414 | 56/M | IHD | II | HF510 | 73/M | V | II |
| HF415 | 69/M | IHD | II | HF502 | 56/M | IHD | III |
| HF416 | 75/M | IHD | II | HF513 | 60/M | IHD | II |
| HF418 | 79/F | IHD | III | HF517 | 68/M | IHD | II |
| HF421 | 52/F | IHD | III | HF523 | 76/F | IHD | II |
| HF422 | 66/M | C | II | HF525 | 50/M | C | III |
| HF423 | 69/M | IHD | II | HF527 | 66/M | IHD | III |
| HF424 | 56/M | V | III | HF528 | 65/M | IHD | III |
| HF426 | 59/M | IHD | II | HF529 | 69/F | C | II |
| HF429 | 68/M | C | III | HF53 | 49/M | C | II |
| HF430 | 55/F | C | I | HF531 | 69/F | H | III |
| HF431 | 72/M | IHD | II | HF535 | 65/M | C | II |
| HF437 | 59/M | IHD | II | HF537 | 66/M | IHD | II |
| HF446 | 73/M | IHD | II | HF540 | 73/F | IHD | II |
| HF447 | 59/M | IHD | II | HF542 | 74/M | H | II |
| HF45 | 69/M | IHD | II | HF543 | 34/M | IHD | II |
| HF450 | 75/M | IHD | II | HF545 | 34/F | C | II |
| HF452 | 58/M | IHD | III | HF553 | 69/F | IHD | III |
| HF454 | 59/M | V | III | HF557 | 51/M | C | III |
| HF456 | 53/F | C | II | HF560 | 72/M | IHD | II |
| HF460 | 51/M | IHD | III | HF562 | 72/M | IHD | II |
| HF464 | 69/M | IHD | II | HF568 | 63/M | IHD | II |
| HF465 | 59/M | IHD | II | HF572 | 69/M | IHD | II |
| HF466 | 58/F | CO | III | HF577 | 59/M | IHD | II |
| HF467 | 60/F | IHD | II | HF579 | 66/M | IHD | II |
| HF468 | 74/M | IHD | II | HF580 | 67/M | IHD | I |
| HF470 | 53/M | H | II | HF582 | 66/M | IHD | II |
| HF584 | 49/F | C | II | HF613 | 64/F | C | I |
| HF586 | 68/M | IHD | II | HF614 | 59/M | IHD | II |
| HF587 | 62/M | IHD | III | HF621 | 60/F | IHD | II |
| HF59 | 61/M | IHD | III | HF63 | 55/M | IHD | II |
| HF590 | 78/M | IHD | II | HF67 | 19/M | C | III |
| HF595 | 75/F | V | II | HF7 | 53/M | IHD | III |
| HF596 | 59/M | IHD | II | HF73 | 62/M | IHD | II |
| HF597 | 58/M | IHD | II | HF74 | 55/M | IHD | I |
| HF599 | 70/F | H | II | HF75 | 57/M | IHD | I |
| HF6 | 51/M | IHD | III | HF76 | 58/M | IHD | II |
| HF600 | 51/M | IHD | II | HF77 | 58/M | IHD | II |
| HF603 | 62/M | IHD | II | HF78 | 49/F | IHD | II |
| HF607 | 57/M | IHD | II | HF80 | 49/M | V | III |
| HF085 | 64/M | IHD | III | | | | |

IHD = Ischemic heart disease;
C = cardiomyopathy;
O = others;
H = hypertension;
V = heart valve disease;
NYHA class = New York Heart Association functional class

### Results

PCI with the MN-Wilcoxon signed-rank test was applied on the first dataset of 49 patients, and then applied on the larger dataset of the remaining 352 patients. Here 1,000 R-R wave intervals were used to faint the input and output. Each time, a portion of the original R-R wave interval series was treated as the output, and was delayed by one point to form the input.

### Parameter Selection

The input (one-point delayed time series) and output (undelayed time series) data were used to build the parallel cascade model. Since the objective in the present study was to distinguish between surviving and deceased CHF patients, and not to predict the values of future R-R intervals data, it was not necessary to use novel stretches of R-R intervals data to evaluate model accuracy. Basic parameters must be preset in order to build an effective model. These parameters are the memory length (R+1) of the dynamic linear element at the beginning of each cascade, the degree (I) of the polynomial that follows, the maximum number (C) of cascades permitted in the model, and a threshold constant Th based on a correlation test for deciding whether a candidate cascade's reduction of the MSE justifies its addition to the model.

In order to acquire the set of nonlinear models, in this embodiment, the nonlinear degree/was fixed (at I=2), and the memory length R+1 was varied over 1, . . . ,20. Then the nonlinear degree I was set at 1 and the memory length R+1 was chosen to get a corresponding set of PCI models equivalent to a set of first order Volterra series, each having the same number of distinct terms as one of the I=2 models. A cascade was accepted into the model only if its reduction of the MSE, divided by the mean-square of the previous residual, exceeded a specified threshold Th divided by the number of output points used to fit the cascade. For the present test sets, Th was always set at 4.

Setting the maximum number of cascades to be allowed in the model did not present any difficulty. There was no danger of over-fitting the cascades when I=2 or when I=1. The same numbers of distinct teens were introduced in the I=2 model as in the corresponding I=1 model, which were both fit over the same output data record, and then their inn measures were compared using the Wilcoxon test. For example, when R+1=20, and I=2, each cascade reduces to a 2^{nd}-order Volterra series with memory length 20, and there are 231 distinct kernel values. The same is true for the overall model, even if there are a large number of cascades in total. This model is then compared with a model having R+1=230, I=1, which also has 231 distinct kernel values. Since the data records used were each 1,000 points long (about 12 minutes in duration), ample data existed for accommodating this number of kernel values and there was no danger of over-fitting the model. This is because, in the present study, the number of distinct kernel values was at most 231, which was much less than the number of data points used in the identification. The maximum number C of cascades allowable simply needed to be greater than the number of cascades that were ever chosen for the I=1 and I=2 cases. In this study, C was set at 200. Also, the R-R intervals 1002-2001 of each patient's R-R series were always used, and no attempt was made to select other sections of the data to “improve” results.

### Results for the Smaller Test Set

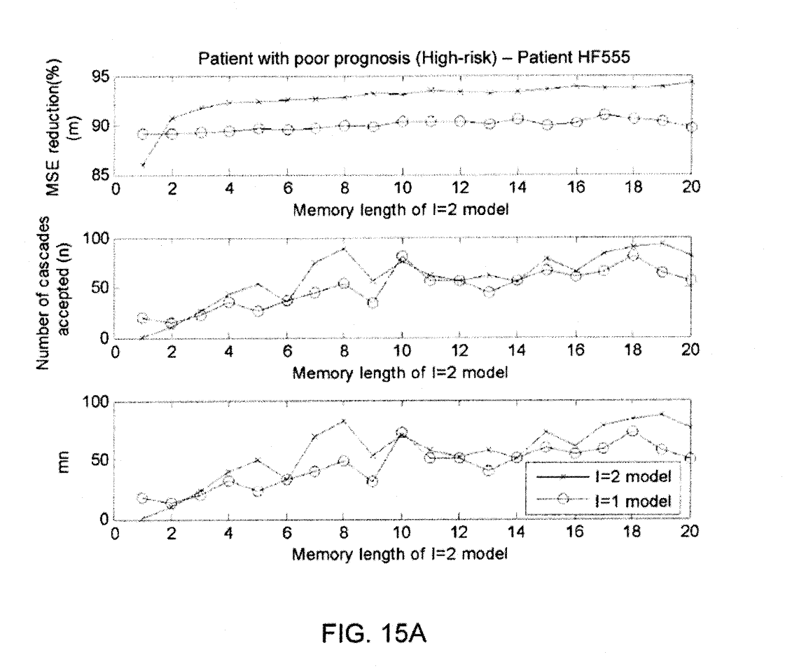

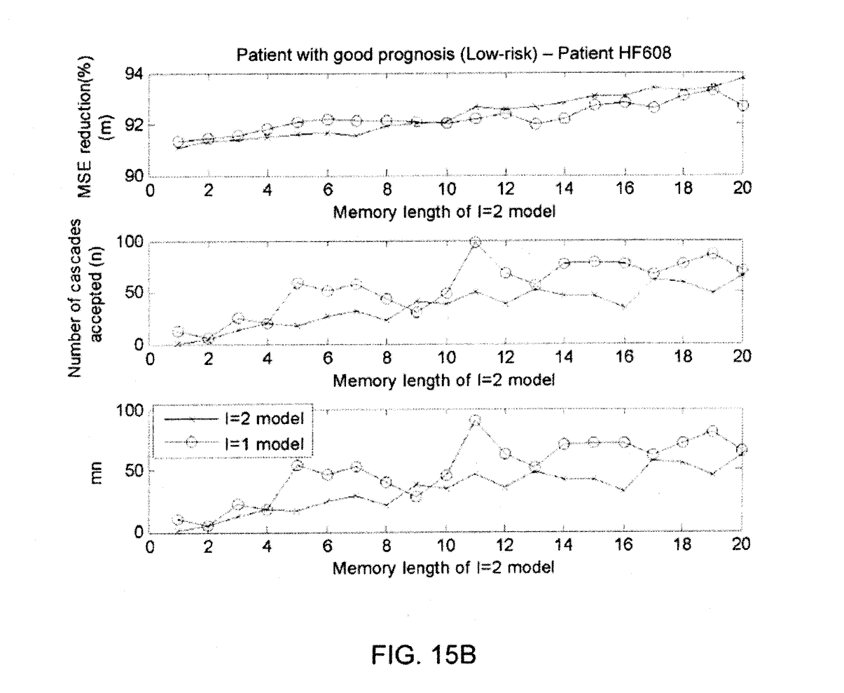

Over the smaller set of 49 patients, PCI recognized all 22 dead patients (by detecting nonlinearity), and 22 of 27 surviving patients (by not detecting nonlinearity). Five patients who survived in the study were misclassified (i.e., nonlinearity detected) as deceased patients. FIGS. 15A and 15B illustrate the % MSE reduction and the number of cascades accepted comparison between a patient with poor prognosis (who ended up dying during this study, patient HF555) and a surviving patient (HF608), respectively. In FIG. 15A, the high-risk, or poor prognosis patient shows greater % MSE reduction and number of cascades accepted for I=2 models than for I=1 models, unlike the low-risk patient of FIG. 15B.

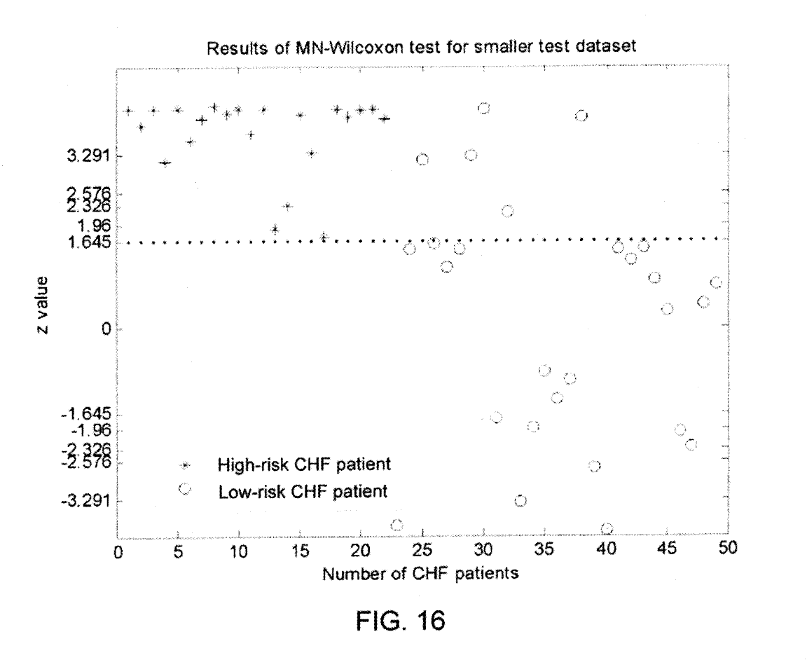

FIG. 16 displays the z values when the MN-Wilcoxon signed-rank test is applied, for the smaller test dataset. All of the z values of the 22 high-risk patients (who died during the five years of study) are above approximately 1.645. Ordinarily 1.645 indicates the 0.05 significance level for detecting nonlinearity on a one-tailed test (the dotted line in FIG. 16). This threshold value is obtained from the unit normal distribution. However, in calculating z via Eq (14), a smaller denominator than usual was used (because the value used for Q was one less than usual in Eq (13)), resulting in a larger |z|. Hence throughout this patent application, the z-value of 1.645 at or above which high-risk was declared only represents approximately a 0.064 level of significance on a one-tailed test. Of the 27 low-risk patients (in this case, surviving patients), the z values of 22 patients are less than approximately 1.645. That means the hypothesis of nonlinearity may be rejected. However, five of 27 low-risk patients still show nonlinearity comparable to the high-risk patients. When a 0.05 significance level is used, nonlinearity is not detected in one high-risk patient, and is detected in five low-risk patients.

### Results for the Larger Data Set

Following the promising results for the smaller test data set, the larger test set was used to verify the efficiency and accuracy of PCI with MN-Wilcoxon signed-rank test. The larger data set includes 352 CHF patients: 121 patients died during the 5-year study, while 231 patients survived. As for the smaller test set, 1,000 points of R-R intervals data were used to form the input/output. Again, the threshold constant Th was set at 4, and the maximum number C of cascades allowed was set at 200.

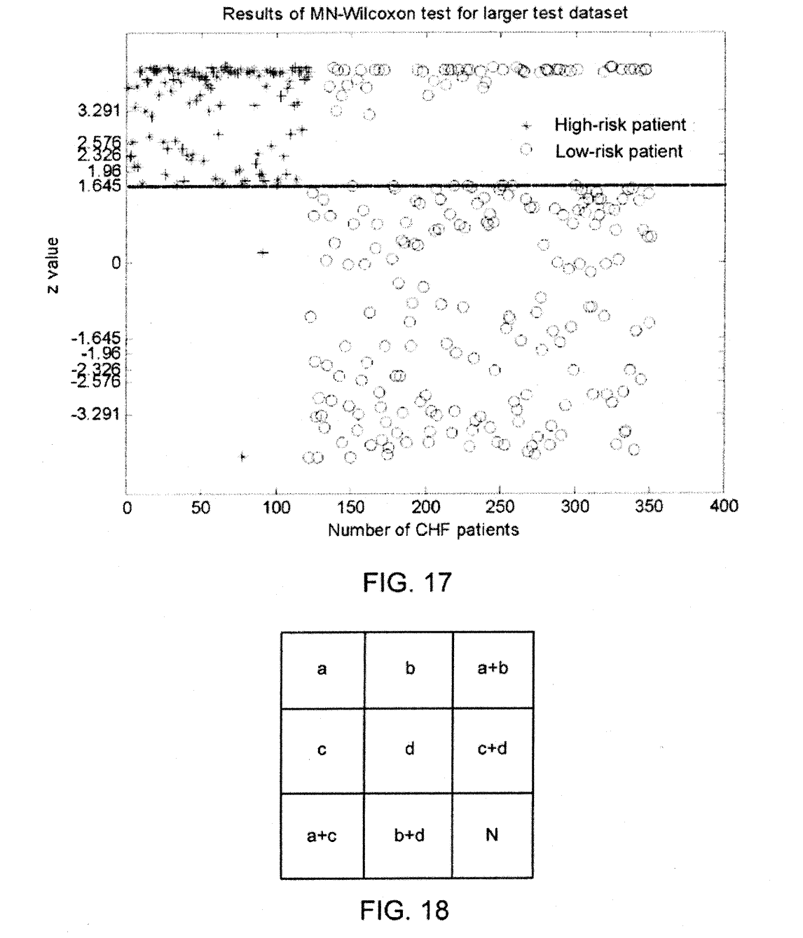

FIG. 17 shows the z values when the MN-Wilcoxon signed-rank test is applied, for the larger test dataset. The z values of 119 of the 121 high-risk patients (those who died during the five years of study) are above approximately 1.645. Due to the way z-values were calculated, 1.645 only indicates about the 0.064 significance level for detecting nonlinearity on a one-tailed test (the dashed line in FIG. 17). Nonlinearity cannot be detected for 2 high-risk patients, who are misclassified as low-risk patients. Of the 231 low-risk CHF patients (in this case, patients who survived the study), the z values of 178 patients are less than approximately 1.645, i.e., the hypothesis of nonlinearity may be rejected. In summary, 119 of the 121 high-risk CHF patients show statistically significant evidence of nonlinearity. For 178 of 231 low-risk patients, the hypothesis of nonlinearity may be rejected. Only 53 of the 231 low-risk patients show nonlinearity, and are misclassified as high-risk patients. However, the NYHA class of 13 of the 53 patients who were misclassified as high-risk by PCI is Class III, which means these patients have marked limitation of activity, and they are comfortable only at rest. These patients may be defined as hidden severe CHF patients. Although a z-value threshold of approximately 1.645 was used in the examples herein, due to the way z-values had been calculated here, this threshold corresponded to about 0.064 level of significance on a one-tailed test. Other embodiments may use higher or lower thresholds depending on the desired significance level. For example, when a 0.05 significance level is used, nonlinearity is not detected in ten high-risk patients, and is detected in 53 low-risk patients.

### Predicting Sudden Cardiac Death

Of the 352 patients in the larger set, 180 were predicted to be low-risk, and 172 to be high-risk. The predicted low-risk group actually included 2 who died, but they were from progressive heart failure, not from sudden death. The predicted high-risk group contained all 42 sudden deaths. So 42/172 (24.4%) of predicted high-risk patients actually had sudden deaths, while 0% of predicted low-risk patients died suddenly. Simplistically, this makes the hazard ratio for sudden death (of the high-risk relative to the low-risk group) infinite. If we combine sudden and progressive heart failure deaths then there were 88 (51.2%) such deaths in the predicted high-risk group, & only 2 (1.1%) in the predicted low-risk group, so the hazard ratio for sudden or progressive heart failure death is roughly 51.2/1.1=46. When a 0.05 significance level is used, 162 patients are predicted to be high-risk, with 38 sudden deaths, while 190 patients are predicted to be low-risk, with 4 sudden deaths.

### Accuracy of Detection

One straightforward measure of accuracy is the Matthews' correlation coefficient r which is described in an article written by B. W. Matthews, entitled “Comparison of the predicted and observed secondary structure of T4 phage lysozyme” as published in Biochem. Biophys. Acta 1975, 405, 442-451, which has been used extensively to evaluate the performance of various prediction algorithms. It combines both sensitivity and specificity into one measure and relies on four values that satisfy TP+TN+FP+FN=N (total number of patients): TP (the number of high-risk patients who are predicted correctly), TN (the number of low-risk patients who are predicted correctly), FN (the number of high-risk patients who are not predicted correctly), and FP (the number of low-risk patients who are not predicted correctly). The Matthews correlation coefficient is calculated as follows (Equation (15)):

$$r = \frac{TP * TN - FP * FN}{\sqrt{( TP + FP ) ( TP + FN ) ( TN + FP ) ( TN + FN )}} \qquad ( 15 )$$

The Matthews' correlation coefficient ranges from −1 to +1. A value of 0 signifies that the prediction is completely random, while +1 signifies a perfect prediction, and −1 signifies that every prediction was incorrect.

The statistical significance of a particular Matthews correlation coefficient can be determined using chi square distributions. The chi square test, as described by Richard Lowry, in a publication entitled Concepts and Applications of Inferential Statistics, http://faculty.vassar.edu/lowry/webtext.html, Chapter 8, 2009, can be used to assess whether paired observations on two variables, expressed in a contingency table, are independent of each other. The test cannot be used when expected frequencies are too low, e.g. if expected frequencies are below 10 when the degree of freedom is 1. In this study, the Yates'-corrected chi square test was used when the sample size was too large to use Fisher's exact test. Equation (16) is used for the Yates'-corrected chi square test.

$${χ}^{2} = {\sum }_{i = 1}^{F} \frac{{( \vert {O}_{i} - {E}_{i} \vert - 0.5 )}^{2}}{{E}_{i}} \qquad ( 16 )$$

where Oᵢ is an observed frequency, and Eᵢ is an expected (theoretical) frequency asserted by the null hypothesis, and F=4, the number of cells in the 2×2 contingency table. The test provides a P-value, the non-directional or 2-tailed probability of obtaining by chance a chi-square value at least as large as the calculated value.

Fisher's exact test, as described by Richard Lowry, in a publication entitled Concepts and Applications of Inferential Statistics, http://faculty.vassar.edu/lowry/webtext.html, Chapter 8a, 2009, an alternative to the chi square test, may be used to determine if there are nonrandom associations between two categorical variables, and is suitable for relatively small samples, typically for the special case of two rows by two columns. In a 2×2 contingency table as illustrated in FIG. 18, a is the number of high-risk patients who were predicted correctly, b is the number of low-risk patients who were predicted incorrectly, c is the number of high-risk patients who were predicted incorrectly, and d is the number of low-risk patients who were predicted correctly. The marginal totals are a+b (the total number of patients who were predicted to be high-risk), c+d (the total number of patients who were predicted to be low-risk), a+c (the total number of high-risk patients), and b+d (the total number of low-risk patients). Finally, N is equal to a+b+c+d, the total number of patients in the study.

Then Fisher's exact test computes the exact probability (the P-value) of obtaining by chance a Matthews' correlation coefficient of the same or larger magnitude than the observed value, given the observed marginal totals. This is the 2-tailed probability. The 1-tailed probability adds the condition that the Matthews' correlation obtained by chance has the same sign as the observed value.

After calculating the Matthews' correlation coefficient and the P-value of Fisher's exact test or of the Yates'-corrected chi square test, the accuracy of distinguishing the high-risk CHF patients from the low-risk patients by PCI with MN-Wilcoxon test is summarized in Table 7. For the smaller test set (49 patients), the Matthews' correlation coefficient is +0.81, and P<3.27×10⁻⁹, 2-tailed, on Fisher's exact test.

TABLE 7
Accuracy of PCI with the MN-Wilcoxon test for the smaller and larger test sets

| | Matthews' | | Sensitivity | | positive | negative |
|---|---|---|---|---|---|---|
| Study | correlation | | for predicting | | predictive | predictive |
| sample | coefficient | P-value | high-risk | specificity | value | value |
| Smaller test | +0.81 | <3.27 × 10⁻⁹ | 100% | 81.48% | 81.48% | 100% |
| set | | | | | | |
| Larger test | +0.72 | <0.0001 | 98.35% | 77.06% | 69.19% | 98.89% |
| set | | | | | | |

Other frequently computed values are sensitivity (the proportion of actual positives [high-risk patients] that are correctly detected), specificity (the proportion of actual negatives [low-risk patients] that are correctly detected), positive predictive value (the proportion of predicted positives that are correct), and negative predictive value (the proportion of predicted negatives that are correct). For the smaller test set, the sensitivity for predicting high-risk is 22/22=100%, and the specificity is 22/27=81.48%. The positive predictive value is 81.48% and the negative predictive value is 100%.

For the larger test set (352 patients), Matthews' correlation coefficient of nonlinearity with unfavourable outcome (high-risk) is +0.72, P<0.0001, 2-tailed. Fisher's exact test could not be used here because the marginal totals are too large, so the P-value is for the Yates-corrected chi-square test. The sensitivity for predicting unfavourable outcome is 119/121=98.35%, while the specificity is 178/231=77.06%. The positive predictive value is 119/172=69.19% , and the negative predictive value is 178/180=98.89%. Thus, consistent accuracy was observed between the smaller and larger test sets.

In this experiment, PCI with the MN-Wilcoxon signed-rank test was used for distinguishing high-risk CHF patients from low-risk CHF patients. A smaller test set (49 CHF patients) was used first, and the resulting sensitivity for predicting high-risk was 100%, and the specificity was 81.48%. On a larger test set (another 352 CHF patients), the sensitivity for predicting unfavourable outcome (high-risk) was 98.35%, while the specificity was 77.06%. Consistent results over the two test sets have been obtained by using PCI and comparing pairs of I=2 and I=1 models: for CHF patients, nonlinearity is associated with unfavorable outcome (for example, death), while patients for whom nonlinearity cannot be detected tend to have good outcomes. This result is significant for diagnosis and management of severe CHF.

### Experiment to Compare Pairs of Nonlinear Models

As discussed above, the first and second PCI models which are paired in the statistical comparison may both be nonlinear, depending on the embodiment. Recall that delaying the original signal, for present purposes using a delay of 1, can be used to create the input. The original signal is used to form the desired output. In the previous embodiment, the input and output were used to find a series of 1=2 and I=1 PCI models (in the alternative nonlinear versus substantially linear case), which are then compared in pairs. An 1=1 model is equivalent to a linear system (where the input and its delayed values are each raised to the 1st power), plus a constant.

Instead of comparing I=1 and I=2 models, we can compare pairs of nonlinear models, where one has a shorter memory than the other but both models have the same number of distinct terms. A simple way of doing this is to raise each input value to some power p before fitting each I=1 model [equivalent to beginning each cascade with a simple p-th power static nonlinearity so that the overall cascade is not an LN structure]. In the first two experiments reported below, this change in the input was made only before fitting the I=1 models, and for simplicity not for the I=2 models (which are already nonlinear). Each of the new “I=1” models is then equivalent to a system where the input and its delayed values are each raised to the power p, plus a constant. For p≠1, these new “I=1” models will not have any linear terms. In the third experiment below, the change in the input was also made before fitting the I=2 model, so for that experiment no cascades in any of the models had the LN structure.

Three experiments are reported here of comparing nonlinear models in pairs, for different powers of p:

First Nonlinear Model Pair Test: p=0.5

In this example, the longer memory length model in each pair had highest degree of ½ and did not include a linear component (degree=1) at all. This is the model that resulted from taking the square root of each input value before fitting an I=1 model. Note that an R-R interval length is never negative, so there is no problem taking the square-root of such a value. The shorter memory length model in each pair was of degree 2 and was not dominated by a linear component. The latter model resulted from fitting an I=2 model without first taking the square root of each input value. The two models had the same number of distinct terms. When tested over the previously described small set of 49 CHF patients, the sensitivity for predicting death was 100% and the specificity was 74%. Matthews' correlation coefficient was +0.75, P<1.24×10⁻⁷ on Fisher's exact test (two-tailed). In particular, all 22 high risk CHF patients (in this case, patients who ultimately died during the study) were correctly classified, as were 20 of 27 low-risk CHF patients (in this case, patients who survived the study). Note that fractional powers can also be introduced by replacing the polynomial in each cascade by a linear combination of fractional powers (taking care that, for example, the square root of a negative value is never required).

Second Nonlinear Model Pair Test: p=2

In this example, the longer memory length model in each pair had highest degree of 2 and did not include a linear component (degree=1) at all. This is the model that resulted from squaring each input value before fitting an I=1 model. The shorter memory length model in each pair was again of degree 2 and was not dominated by a linear component. The latter model resulted from fitting an I=2 model without first squaring each input value. Both models had the same number of distinct terms. This time the sensitivity over the same set of 49 patients for predicting high-risk CHF patients was 90.9% while the specificity was 66.6%. Matthews' correlation coefficient was +0.58, P<10⁻⁴ on Fisher's exact test (two-tailed). In particular, 20 of 22 high-risk patients were correctly classified, as were 18 of 27 low-risk patients. In this example, a preference for shorter memory length models predicted death, and not degree of nonlinearity, which was 2 for both models of each pair. In other words, the present methods can distinguish between longer and shorter memory length models.

Similar results were obtained in other examples where both models in each pair were nonlinear and neither model contained a dominating linear term.

Third Nonlinear Model Pair Test: p=2

In this example, each input value was squared before fitting both the I=1 (resulting in 2^{nd} degree nonlinear) and I=2 (resulting in 4^{th} degree nonlinear) models. This is equivalent to beginning each cascade in all the models with a static nonlinearity that is a simple squarer. This approach still distinguished well between survivors and deceased. This time a preference for 4^{th} rather than 2^{nd} degree nonlinearities predicted death. The sensitivity over the same set of 49 patients for predicting death was 86.4% while the specificity was 63%. Matthews' correlation coefficient was +0.5, P<0.0011 on Fisher's exact test (two-tailed).

The advantages of a method and system of predicting clinical outcome for a patient with congestive heart failure have been discussed herein. Moreover, the same invention can be applied for other purposes, for example to distinguish between persons with and without heart failure. In one experiment involving treated patients, the I=2 versus I=1 predictor (in the alternative nonlinear versus substantially linear embodiment used to obtain the larger and smaller test set results in Table 7) was able to distinguish between heart failure patients and normals. Detection of nonlinearity predicted heart failure: Matthews' correlation coefficient was +0.3, Fisher's exact test probability P<0.028021 (two-tailed) over the 60 persons in this set. With training exemplars for high-risk and-low risk patients, the system and method could similarly be applied to distinguish between high-risk and low-risk patients who have had acute myocardial infarction. An embodiment of the claimed invention has also been successfully demonstrated on non-CHF test data, correctly detecting nonlinearity in an experimental time series (512 points) of emission of an NH3 laser from an apparatus designed to produce Lorenz-like chaos, and correctly not detecting nonlinearity in an experimental time series of the intensity of a variable dwarf star [both time series are described in Weigend, A. S. and Gershenfeld, N. A. “Time series prediction” Santa Fe Inst. Studies in Sciences of Compexity, Vol. XV, Addison-Wesley, Reading, Mass., 1994]. As further demonstrations, the results for some numerically generated nonlinear examples are summarized in Table 8. It shows the maximum percentages of correlated noise that can be added to a 512-point-long series before the nonlinear component is no longer detected with 0.05 significance level by an I=2 versus I=1 PCI predictor (in the alternative nonlinear versus substantially linear embodiment). Most of the discrete series here (except the Henon and logistic maps) have non-polynomial, non-Volterra functional forms [Barahona, M. and Poon, C. S. “Detection of nonlinear dynamics in short, noisy time series.” Nature 381, 215-217, 1996]. Lorenz and Duffing evolve around several ghost centres [Barahona and Poon, 1996]. Series D is from high-dimensional systems with a dimension of 9, and the Mackey-Glass equation is a chaotic series from nonlinear delayed feedback mechanisms with implicit dimension of seven [Barahona and Poon, 1996]. The robustness of PCI with MN-Wilcoxon signed-rank test was tested in the presence of colored measurement noise (with the same autocorrelation as the original series). Even with such short series (512 points), nonlinearity was detected under high levels of noise.

All of the examples in Table 8 were also successfully tested by Barahona and Poon in their Nature (1996) paper using an approach based on a Volterra-Wiener-Korenberg series. However Barahona and Poon used 1000 point series, so that their results cannot be compared with those in Table 8 which are based on 512 point series. Also PCI offers significant advantages in decreased run times.

TABLE 8
Summary of the results of nonlinear examples (PCI with MN-
Wilcoxon test)

| | | Continuous | |
|---|---|---|---|
| Discrete systems | % of noise | systems | % of noise |
| Logistic map | 70% | Rossler | 75% |
| Henon map | 80% | Duffing | 40% |
| Ikeda map | 80% | Lorenz II | 50% |
| Ecological model | 50% | Series D | 50% |
| | | Mackey-Glass | 50% |

Embodiments discussed have been described by way of example in this specification. It will be apparent to those skilled in the art that the forgoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and the scope of the claimed invention. Additionally, the recited order of processing elements or sequences, or the use of numbers, letters, or other designations therefore, is not intended to limit the claims to any order, except as may be specified in the claims. Accordingly, the invention is limited only by the following claims and equivalents thereto.

1. A method of predicting a clinical outcome for a patient with congestive heart failure, comprising:
a) providing a biomarker dataset;
b) identifying a plurality of nonlinear first parallel cascade identification (PCI) models based on the biomarker dataset, each of the nonlinear first PCI models having a number of distinct terms;
c) identifying one or more second PCI models based on the biomarker dataset, each of the one or more second PCI models having a number of distinct terms which corresponds to the number of distinct terms for one or more of the nonlinear first PCI models;
d) statistically comparing each of the plurality of nonlinear first PCI models to one of the one or more second PCI models having a corresponding number of distinct terms to determine at least one of a preference for higher versus lower degree of nonlinearity or a preference for shorter versus longer memory length; and
e) predicting the clinical outcome based on the higher versus lower degree of nonlinearity preference or the memory length preference.

2. The method of claim 1, wherein the biomarker dataset comprises electrocardiogram (ECG) data.

3. The method of claim 1, wherein the biomarker dataset comprises a metric based on electrocardiogram (ECG) data.

4. The method of claim 1, wherein the biomarker is selected from the group consisting of:
an R-R interval;
a QT interval;
an ST segment;
a QRS complex interval;
a heart rate;
the amplitude of the T wave;
a PR interval;
the amplitude of the P wave; and
a direction of a significant axis determined by principal component analysis.

5. The method of claim 1, wherein each of the one or more second PCI models based on the biomarker dataset comprises a substantially linear PCI model based on the biomarker dataset.

6. The method of claim 5, wherein:
each of the plurality of nonlinear first PCI models comprises a first memory length; and
each of the one or more substantially linear second PCI models comprises a second memory length.

7. The method of claim 6, wherein the first memory length of each of the plurality of nonlinear first PCI models is different than the second memory length of the substantially linear second PCI model to which it is statistically compared.

8. The method of claim 5, wherein the one or more substantially linear second PCI models comprise a nonlinear PCI model having a degree of nonlinearity substantially equal to one.

9. The method of claim 1, wherein each of the one or more second PCI models based on the biomarker dataset comprises a nonlinear PCI model based on the biomarker dataset.

10. The method of claim 9, wherein:
each of the plurality of nonlinear first PCI models comprises:
a first memory length; and
a degree of nonlinearity; and
each of the one or more nonlinear second PCI models comprises:
a second memory length; and
an other degree of nonlinearity.

11. The method of claim 10, wherein the first memory length of each of the plurality of nonlinear first PCI models is different from the second memory length of the nonlinear second PCI model to which it is statistically compared.

12. The method of claim 10, wherein the degree of nonlinearity of each of the plurality of nonlinear first PCI models is different from the other degree of nonlinearity of the nonlinear second PCI model to which it is statistically compared.

13. The method of claim 1, wherein statistically comparing each of the plurality of nonlinear first PCI models to one of the one or more second PCI models having the corresponding number of distinct terms to determine the preference for higher versus lower degree of nonlinearity or the memory length preference comprises:
using a Wilcoxon Signed-Ranks test to determine whether the plurality of nonlinear first PCI models consistently have larger mean square error reductions or more cascades accepted than the one or more second PCI models.

14. The method of claim 1, wherein statistically comparing each of the plurality of nonlinear first PCI models to one of the one or more second PCI models having the corresponding number of distinct terms to determine the preference for higher versus lower degree of nonlinearity or the memory length preference comprises:
using an MN-Wilcoxon Signed-Ranks test to determine whether the plurality of nonlinear PCI models consistently have larger mean square error reductions or more cascades accepted than the one or more second PCI models.

15. The method of claim 14, wherein the MN-Wilcoxon Signed-Ranks test comprises a z-value to test for a hypothesis of preference for higher degree of nonlinearity or of preference for shorter memory length; and wherein a z-value of greater than approximately 1.645 is indicative of the hypothesis of preference for higher degree of nonlinearity or of preference for shorter memory and therefore the predicted clinical outcome based on the preference for higher degree of nonlinearity or shorter memory length preference is that the patient with congestive heart failure is a high-risk congestive heart failure patient.

16. The method of claim 1, wherein predicting the clinical outcome based on the preference for higher versus lower degree of nonlinearity or memory length preference comprises predicting that the patient with congestive heart failure is a high-risk congestive heart failure patient if a hypothesis of preference for higher degree of nonlinearity or of shorter memory length preference is supported.

17. The method of claim 1, wherein predicting the clinical outcome based on the preference for higher versus lower degree of nonlinearity or memory length preference comprises predicting that the patient with congestive heart failure is a high-risk congestive heart failure patient when there is a preference for higher degree of nonlinearity or shorter memory length.

18. A method of predicting a clinical outcome for a patient with congestive heart failure, comprising:
a) providing a biomarker dataset;
b) identifying a plurality of nonlinear first black-box models based on the biomarker dataset, each of the nonlinear first black-box models having a number of distinct terms;
c) identifying one or more second black-box models based on the biomarker dataset, each of the one or more second black-box models having a number of distinct terms which corresponds to the number of distinct terms for one or more of the nonlinear first black-box models;
d) statistically comparing each of the plurality of nonlinear first black-box models to one of the one or more second black-box models having a corresponding number of distinct terms to determine a preference for higher versus lower degree of nonlinearity or a preference for shorter versus longer memory length; and
e) predicting the clinical outcome based on the preference for higher versus lower degree of nonlinearity or memory length preference.

19. The method of claim 18, wherein each of the one or more second black-box models based on the biomarker dataset comprises a substantially linear black-box model based on the biomarker dataset.

20. The method of claim 19, wherein the one or more substantially linear second black-box models comprise a nonlinear black-box model having a degree of nonlinearity substantially equal to one.

21.-80. (canceled)
